(19) United States
(12) Patent Application Publication
(10) Pub. No.: US 2012/0044836 A1
(43) Pub. Date: Feb. 23, 2012

(54) MOBILE NETWORK, RADIO ACCESS NODE, SYSTEM INCLUDING A RELAY APPARATUS, AND METHOD THEREOF

(76) Inventors: Sivapathalingham Sivavakeesar, Bracknell Berkshire (GB); Sujith Chandran, Bracknell Berkshire (GB)

(21) Appl. No.: 13/266,225

(22) PCT Filed: Apr. 19, 2010
(86) PCT No.: PCT/JP2010/057307

§ 371 Date: Oct. 25, 2011

(30) Foreign Application Priority Data
Apr. 27, 2009 (GB) 0907213.3

(51) Int. Cl. H04W 88/04; H04W 36/36; H04L 12/28

(52) U.S. Cl. 370/255; 370/315; 370/331

(57) ABSTRACT

A mobile network comprising a relay, a controller in a master-slave arrangement with the relay and one or more user terminals, wherein the controller is operable to control the status of said relay between a standby mode and an active mode dependent upon requests received from said user terminals.

### TECHNICAL FIELD

The present invention relates to a mobile network including a relay apparatus, a radio access node, a system in which said relay and others are operable to function and methods of use thereof. Further, the present invention is desirably used in connection with the Long Term Evolution advanced (LTE-A) standard for mobile network technology.

### BACKGROUND ART

The increase of mobile data, together with an increase of mobile applications (such as streaming content, online gaming and television and internet browsers) has prompted work on the LTE standard. This has been superseded by the LTE-A standard.

To aid further understanding of the present invention, a brief disclosure of LTE and LTE-A architecture will now be provided in conjunction with FIG. 1. The radio access in the LTE and LTE-A standard is generally termed Evolved Universal Terrestrial Radio Access Network (E-UTRAN). Certain types of E-UTRANs entities are termed eNode-Bs, and others termed relays.

The network uses a new Packet Core—the Evolved Packet Core (EPC) network architecture to support the E-UTRAN.

The pertinent functional elements are discussed below.

Evolved Universal Terrestrial Radio Access Network (E-UTRAN)

The E-UTRAN for LTE consists of a single node, generally termed the eNodeB (eNB) that interfaces with a given mobile phone (typically termed user equipment, or user terminal). For convenience, the term UE—user equipment—will be used hereafter. The eNB hosts the physical layer (PHY), Medium Access Control layer (MAC), Radio Link Control (RLC) layer, and Packet Data Control Protocol (PDCP) layer that include the functionality of user-plane header-compression and encryption. It also offers Radio Resource Control (RRC) functionality corresponding to the control plane. The evolved RAN performs many functions including radio resource management, admission control, scheduling, enforcement of negotiated up-link QoS, cell information broadcast, ciphering/deciphering of user and control plane data, and compression/decompression of down-link/up-link user plane packet headers.

Serving Gateway (SGW)

The SGW routes and forwards user data packets, while also acting as the mobility anchor for the user plane during interlay handovers. For idle state UEs, the SGW terminates the downlink data path and triggers paging when downlink data arrives for the UE. It manages and stores UE contexts. The SGW also performs replication of the user traffic in case of lawful interception.

Mobility Management Entity (MME)

The MME is the key control-node for the LTE access-network. It is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signalling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signalling and handles the security key management. Lawful interception of signalling is also supported by the MME. The MME also provides the control plane function for mobility between LTE and 2G/3G access networks with the S3 interface terminating at the MME from the SGSN. The MME also terminates the S6a interface towards the home HSS for roaming UEs.

Packet Data Network Gateway (PDN GW)

The packet data network gateway provides connectivity to the UE to external packet data networks by being the point of exit and entry of traffic for the UE. A UE may have simultaneous connectivity with more than one PDN GW for accessing multiple PDNs. The PDN GW performs policy enforcement, packet filtering for each user, charging support, lawful interception and packet screening.

Home Subscriber Server (HSS)

The Home Subscriber Server (HSS) is a master user database that supports the IMS network entities that handle wireless communications sessions. It contains the subscription-related information, performs authentication and authorization of the user, and can provide information about the subscriber's location and IP information.

The table below describes the interfaces used between the primary functional elements.

| LTE | |
|---|---|
| REFERENCE | |
| POINT | DESCRIPTION |
| S1-MME | Reference point for the control plane |
| | protocol between EUTRAN and MME. The |
| | protocol over this reference point is |
| | eRANAP and it uses Stream Control |
| | Transmission Protocol (SCTP) as the |
| | transport protocol. |
| S1-U | Reference point between EUTRAN and |
| | SGW for the per-bearer user plane |
| | tunnelling and interlay path switching |
| | during handover. The transport protocol |
| | over this interface is GPRS Tunnelling |
| | Protocol-User plane (GTP-U). |
| S2a | It provides the user plane with related |
| | control and mobility support between |
| | trusted non-3GPP IP access and the |
| | Gateway. S2a is based on Proxy Mobile IP. |
| | To enable access via trusted non-3GPP IP |
| | accesses that do not support PMIP, S2a |
| | also supports Client Mobile IPv4 FA mode. |
| S2b | It provides the user plane with related |
| | control and mobility support between |
| | evolved Packet Data Gateway (ePDG) and |
| | the PDN GW. It is based on Proxy Mobile |
| | IP. |
| S2c | It provides the user plane with related |
| | control and mobility support between UE |
| | and the PDN GW. This reference point is |
| | implemented over trusted and/or |
| | untrusted non-3GPP Access and/or 3GPP |
| | access. This protocol is based on Client |
| | Mobile IP co-located mode. |
| S3 | It is the interface between SGSN and MME |
| | and it enables user and bearer information |
| | exchange for inter 3GPP access network |
| | mobility in idle and/or active state. It is |
| | based on Gn reference point as defined |
| | between SGSNs. |
| S4 | It provides the user plane with related |
| | control and mobility support between |
| | SGSN and the SGW and is based on Gn |
| | reference point as defined between SGSN |
| | and GGSN. |
| S5 | It provides user plane tunnelling and |
| | tunnel management between SGW and |
| | PDN GW. It is used for SGW relocation due |
| | to UE mobility and if the SGW needs to |
| | connect to a non-collocated PDN GW for |
| | the required PDN connectivity. Two |
| | variants of this interface are being |
| | standardized depending on the protocol |
| | used, namely, GTP and the IETF based |
| | Proxy Mobile IP solution [3]. |
| S6a | It enables transfer of subscription and |
| | authentication data for |
| | authenticating/authorizing user access to |
| | the evolved system (AAA interface) between |
| | MME and HSS. |
| S7 | It provides transfer of (QoS) policy and |
| | charging rules from Policy and Charging |
| | Rules Function (PCRF) to Policy and |
| | Charging Enforcement Function (PCEF) in |
| | the PDN GW. This interface is based on |
| | the Gx interface. |
| S10 | Reference point between MMEs for MME |
| | relocation and MME to MME information |
| | transfer. |
| S11 | Reference point between MME and SGW. |
| SGi | It is the reference point between the PDN |
| | GW and the packet data network. Packet |
| | data network may be an operator-external |
| | public or private packet data network or |
| | an intra-operator packet data network, |
| | e.g. for provision of IMS services. This |
| | reference point corresponds to Gi for |
| | 2G/3G accesses. |
| Rx+ | The Rx reference point resides between the |
| | Application Function (Operators IP |
| | Services) and the PCRF in the 3GPPTS |
| | 23.203. |
| LTE-U | This is the reference point between the |
| | user terminal and the eNB. |
| Wn* | This is the reference point between the |
| | Untrusted Non-3GPP IP Access and the |
| | ePDG. Traffic on this interface for a UE |
| | initiated tunnel has to be forced towards |
| | ePDG. |

The purpose of the LTE-A standard system is to allow for service providers to reduce the cost of providing a network by sharing E-UTRANs but each having separate core networks. This is enabled by allowing each E-UTRANs—such as an eNB—to be connected to multiple core networks. Thus, when a UE requests to be attached to a network, it does so by sending an identity of the appropriate service provider to the E-UTRAN.

LTE and LTE-A uses multiple access schemes on the air interface: Orthogonal Frequency Division Multiple Access (OFDMA) in downlink and Single Carrier Frequency Division Multiple Access (SC-FDMA) in uplink. Furthermore, MIMO antenna schemes form an essential part of LTE. E-UTRA employs two synchronisation channels—primary and secondary—for the UE air interface synchronisation.

The layer-1 and layer-2 protocols of the air interface terminate in the wireless device and in the eNB. The layer-2 protocols include the medium access control (MAC) protocol, the radio link control (RLC) protocol, and the packet data convergence protocol (PDCP). The layer-3 radio resource control (RRC) protocol also terminates in both the wireless device and the base station. The protocols of the non-access stratum (NAS) in the control plane terminate in the wireless device and in the mobility management entity (MME) of the core network.

LTE employs the shared-channel principle, which provides multiple users with dynamic access to the air interface.

FIG. 2 shows the protocol layer architecture of a typical user terminal, eNodeB and mobility management entity. In the control-plane, the non-access stratum protocol, which runs between the MME and the UE, is used for control-purposes such as network attach, authentication, setting up of bearers, and mobility management. All NAS messages are ciphered and integrity protected by the MME and UE. The RRC layer in the eNB makes handover decisions based on neighbour cell measurements sent by the UE, pages for the UEs over the air, broadcasts system information, controls UE measurement reporting such as the periodicity of Channel Quality Information (CQI) reports and allocates cell-level temporary identifiers to active UEs. It also executes transfer of UE context from the source eNB to the target eNB during handover, and does integrity protection of RRC messages. The RRC layer is responsible for the setting up and maintenance of radio bearers.

The PDCP layer is responsible for compressing/decompressing the headers of user plane IP packets.

The RLC layer is used to format and transport traffic between the UE and the eNB. The RLC layer also provides in-sequence delivery of Service Data Units (SDUs) to the upper layers and eliminates duplicate SDUs from being delivered to the upper layers. It may also segment the SDUs depending on the radio conditions.

Like other systems, there are two levels of re-transmissions for providing reliability, namely, the Hybrid Automatic Repeat reQuest (HARQ) at the MAC layer and outer ARQ at the RLC layer. The outer ARQ is required to handle residual errors that are not corrected by HARQ that is kept simple by the use of a single bit error-feedback mechanism. An N-process stop-and-wait HARQ is employed that has asynchronous re-transmissions in the down-link and synchronous re-transmissions in the up-link. Synchronous HARQ means that the re-transmissions of HARQ blocks occur at pre-defined periodic intervals. Hence, no explicit signalling is required to indicate to the receiver the retransmission schedule. Asynchronous HARQ offers the flexibility of scheduling re-transmissions based on air interface conditions.

To cater for the ever increasing demand for a ubiquitous high-bandwidth delay sensitive system, the evolution of LTE to “LTE-Advanced” (LTE-A) is required. As the first step, the 3 GPP has set out very stringent target requirements for the evolving LTE-A systems in terms of achievable bit rate for both down-link and up-link, delay performance and the number of concurrent voice over internet protocol (VoIP) user support at 5 MHz bandwidth. As part of this, the 3 GPP considers that the cell edge performance needs to be improved.

Relaying has been identified by the 3 GPP as one of the potential technological candidates to enhance the cell edge performance in LTE and LTE-A. However, the existing relaying technologies are too immature for them to be economically adopted by network operators and, hence further work is required for this new technology to be adopted readily in the evolving cellular networks.

There are different categories of relays depending on the layers the relay operation affects. The classification of relays may be summarised as follows; i) Layer 0 (L0) Relay: Repeater—no standard related issue is envisaged, ii) Layer 1 (L1) Relay: Amplify & Forward—an advanced repeater, iii) Layer 2 (L2) Relay: Decode & Forward, and iv) Layer 3 (L3) Relay: Self-backhauling often with IP relaying.

The main deficiency of L1 relay node (RN) is that given that it cannot differentiate between the desired signals and noise/interference, both noise and desired signals are amplified and forwarded. The L1 relay, thus, cannot improve the SINR from input to output. On the other hand, in the case of L2 and L3 relays, the relay operation introduces a significant delay. Most of the L1 and L2 relays require significant modifications to L1 and L2, while some others do not scale well for large scale operation. In general, the main deficiencies of the already proposed relaying mechanisms are that they will bring in additional complexities while introducing additional delay and impairing backward compatibility and relay transparent operation.

The present invention seeks to overcome the above drawbacks, and particularly seeks to provide enhanced cell edge performance.

### SUMMARY OF INVENTION

According to a first aspect of the present invention there is provided a mobile network comprising: 1) a relay; 2) a controller in a master-slave arrangement with said relay; and 3) one or more user terminals, wherein said controller is operable to control the status of said relay between a standby mode and an active mode dependent upon the requests received from said user terminals.

It is preferred that the network is a Long Term Evolution (LTE) or Long Term Evolution advanced (LTE-A) network, and that the controller is an e-NodeB type node.

Preferably the network further comprises a relay gateway operable to assign a temporary identification to said relay when said relay gets itself attached to the network. Another functionality of the relay gateway is to identify the most appropriate eNB to function as the relay's controller. Typically the relay gateway is a software implementation, hardware implementation or a mixer of both and can be housed in the mobility management entity.

Relays are connected to the network via the relay gateway for the purpose of assigning a temporary identification and a master base station, and for improved security.

It is preferred that, in the mobile network, the relay is transparent to the user terminals. In other words, it is preferred that the user terminal considers that it is communicating directly with the e-NodeB.

When the network is active, it is preferred that the relay can invoke an attach procedure to join the network. Hence, the relay attachment procedure is asynchronous and unilateral with respect to the network.

Preferably the relay is operable to revert from an active mode to a standby mode after a predetermined time of non-use has elapsed. In this manner conservation of electrical energy and spectrum resources are achieved.

It is preferred that the network further comprises a relay (different relay from preceding relay), a serving gateway and a mobility management entity (different mobility management entity from preceding management entity), wherein said relay is characterised by maintaining an interface with the serving gateway but not with any mobility management entity thereby only relaying any user-plane traffic but not control-plane signalling traffic.

Preferably the relay is operable to synchronise with the controller using the LTE or LTE-A air interface in the same manner as a user terminal achieves synchronisation. It will be appreciated that the synchronised nature of the relays with the e-NodeB allows the reduction of control plane latency at the time of traffic handover between a relay and the e-NodeB or vice-versa.

According to a second aspect of the present invention there is provided a system for dynamically configuring radio resource in a wireless network, said network comprising a transceiver associated with a cell, one or more relays and one or more user terminals, wherein said one or more user terminals are operable to communicate wirelessly with the transceiver, wherein said network is operable to analyse requests from the said one or more user terminals, and, based on said requests, said network decides whether or not the transceiver is able to handle the requests from said one or more user terminals, and if not, nominate the most appropriate relay from said one or more relays, by running a relay selection algorithm that nominates the most appropriate relay based on the location of the said one or more relays and a signal strength of the said on or more relays, to handle the requests from said one or more user terminals.

Preferably the transceiver is an e-NodeB type node.

It is preferred that said one or more relays are maintained in a standby mode when not in use. It is particularly preferred that each relay has a timer circuit operable to countdown to entry to a sleep or standby mode.

It is preferred that the relays are located towards the periphery of a cell associated with the e-NodeB.

In accordance with a third aspect of the present invention there is provided a radio access node for a LTE or LTE-A network, said network comprising a master node and a serving gateway and one or more user terminals, said radio access node configured to be activated and deactivated by said master node and further operable to maintain an interface with the serving gateway for handling user traffic.

Preferably the network further comprises a mobility management entity and said radio access node does not interface with said mobility management entity.

Preferably the relaying operation of the radio access node is transparent to said user terminals.

For efficiency and backwards compatibility, it is preferred that the radio access node exclusively relays NAS signalling.

According to a fourth aspect of the present invention there is provided a user equipment handover method for a wireless network, said network comprising: i) a plurality of nodes, including a controlling node, a first node and a second node; and ii) a user terminal, wherein said user terminal is located in overlapping service regions of said controlling, first and second nodes such that said user terminal is operable to camp on the controlling node and to subsequently initiate a service request, and on receiving the service request, the controlling node is operable to examine a request for a wireless communication session from the user terminal, and, should the first node ascertain that it is not capable of supporting the communication session of the user terminal, handing said request over to the second node. For example, a user terminal can hand the request over to the second node as an optimal node for handover.

It preferred that, if the first radio access node determines that it is unable to handle the communication session, the method comprises the following steps: 1). establishing a list of potential nodes operable to receive connectivity to the user terminal; 2). notifying the list to the user terminal and causing the user terminal to measure operating parameters of each of the nodes in said list and causing the user terminal to perform UL sounding after allocating necessary resource elements; and 3). notifying the controlling node of said measurements (from both the user terminal and list of potential nodes), such that the controlling node establishes which further radio access node is optimal for said handover.

Preferably the controlling node, after receipt of the measurements from the user terminal, ascertains the quality of service requirements of the user terminal and determines the optimal node based on this information.

Most preferably the first radio access node (controlling node) is an eNodeB, and that the plurality of further nodes at least include relay nodes.

It is preferred that the e-NodeB is responsible for allocating, assigning and configuring the radio resources at the chosen relay.

The present handover, termed herein switchover provides for the controlling node to be responsible for accepting an user terminal's initial session set up within its serving area and after the examination of the initial request the controller may decide to handover to the appropriate relay located either within its domain or in the neighbouring controlling node, if required. This is in addition to the conventional handover that can take place in the middle of an user terminal's active session.

Preferably the handover is rejected if there is not a suitable node included in the established list, or if the QoS is not sufficient to meet the requirements of the user terminal.

Thus, in the present user equipment handover method or switchover, the switchover takes place between any two nodes within the domain or cell of the controlling node. The controlling unit assigns and configures the resources of the relay within its domain while reconfiguring the radio resources of an UE without the said user equipment being aware of the handover.

In order that the present invention be more readily understood, specific embodiments thereof will now be understood with reference to the accompanying drawings.

The foregoing and other objectives, features, and advantages of the invention will be more readily understood upon consideration of the following detailed description of the invention, taken in conjunction with the accompanying drawings.

### BRIEF DESCRIPTION OF DRAWINGS

FIG. 1 shows the architecture of a typical LTE/LTE-A network.

FIG. 2 shows the protocol layer architecture of a typical user terminal.

FIG. 3 shows key aspects of the architecture of an embodiment of the present invention.

FIG. 4 shows the state machine of a relay and possible transitions there between.

FIG. 5 shows a relay attach process.

FIG. 6 shows a relay detach process.

FIG. 7 shows a relay selection algorithm.

FIG. 8 shows a user equipment triggered service request procedure.

FIG. 9 shows a sequence for a dedicated bearer activation.

FIG. 10 shows an overview of relay mobility within a cell.

FIG. 11 shows a switch-over between an M-eNB and a slave relay.

FIG. 12 shows a switch-over between two relays in a cell of an M-eNB.

FIG. 13 shows a switch-over between relays belonging to different M-eNBs.

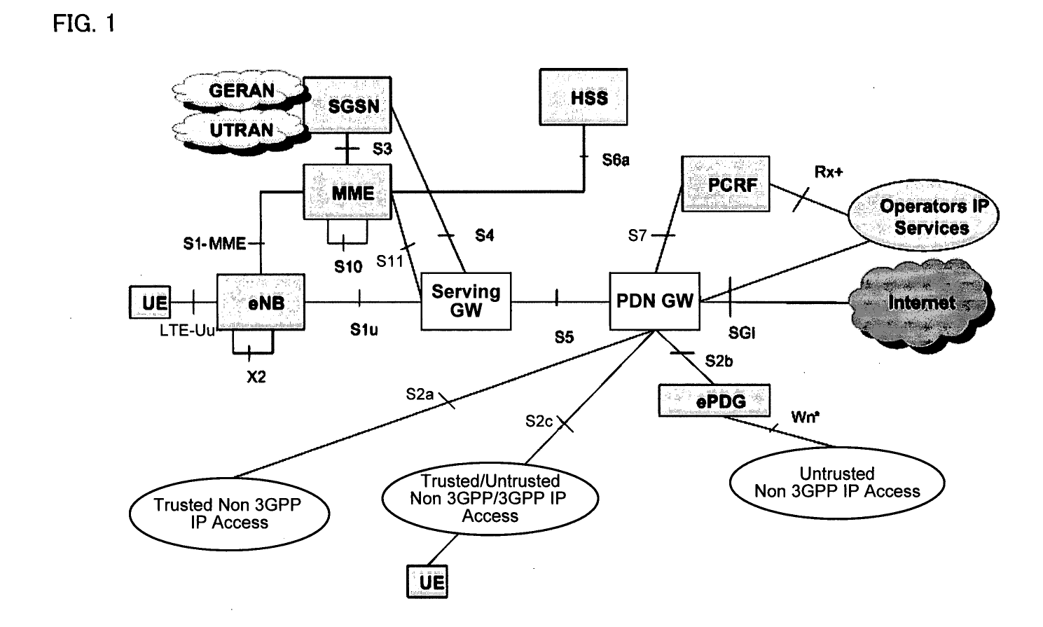

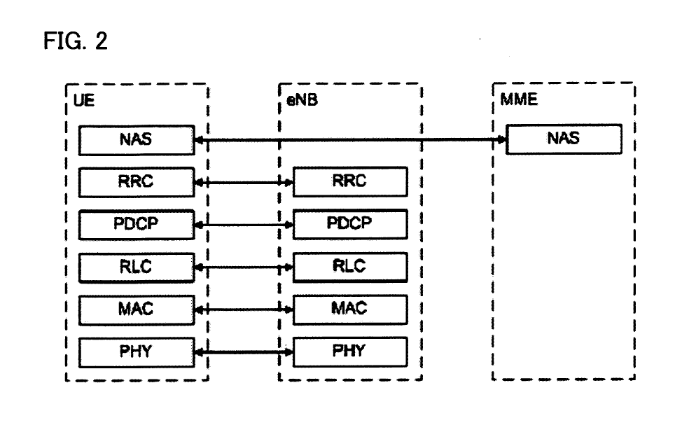

### DESCRIPTION OF EMBODIMENTS

The present embodiments are described with reference to LTE and LTE-A networks, although it is to be understood that the innovations described hereinafter are applicable to other wireless systems.

The present arrangement is operable to function with a wide range of relays currently implemented in wireless networks. Thus, when the term relay is used, it is to be considered in its widest sense. Also included in this term is a new E-UTRAN node called Relay eNB (R-eNB). An R-eNB is a specialized L3 relay, although it substantially differs from a typical L3 relay. The term RN (relay node) is used to refer all relays except R-eNBs.

An R-eNB is a lightweight version of an eNB, and has only a Y2 interface (an interface being very similar to X2) with the eNB to which it is associated with (the latter is termed Master eNB or M-eNB) and an S1-U-like interface with the Serving Gateway, and operates in a slave mode for RRC, RRM and Radio resource allocation operations. The user plane protocol stack of R-eNB is very similar to that of an ordinary eNB or an M-eNB. On the other hand, the control plane protocol stack of an R-eNB is different from RRC and L1 functionality perspectives. Given that an R-eNB does not maintain S1-MME like interface with an MME, any R-eNB needs the assistance of its M-eNB for NAS control plane operations such as EPS bearer management for ongoing sessions of a UE currently served by an R-eNB.

An R-eNB is not a typical relay, as it does not relay the UE related traffic as an R-eNB maintains an S1-U-like interface; however, given that an R-eNB still performs some type of relaying in the case of NAS signalling, the term relaying is still retained here. R-eNBs are, hence, different from an ordinary eNB, home-eNode B (H-eNB), typical L1, L2 or L3 relays and a remote antenna element (RAE). Further, from the EPC's point of view, an R-eNB is not much different from any eNB, and hence the EPC treats any R-eNB like the way it does any eNB except the fact that an EPC does not maintain ay S1-MME-like interface with an R-eNB.

To aid further understanding of an R-eNB, the table below summarizes the differences between an R-eNB and other typical relays.

| | | | L3 | | |
|---|---|---|---|---|---|
| | L1 radio | L2 radio | radio | | |
| | node | node | node | e-NB | R-eNB |
| Synchronisation | ✓ | ✓ | ✓ | ✓ | x |
| Procedures | | | | | |
| Radio Bearer Control | ✓ | ✓ | ✓ | ✓ | x |
| Radio Admission | ✓ | ✓ | ✓ | ✓ | x |
| Control | | | | | |
| Connection Mobility | ✓ | ✓ | ✓ | ✓ | * |
| Control | | | | | |
| Dynamic Resource | ✓ | ✓ | ✓ | ✓ | * |
| Allocation | | | | | |
| Inter-Cell | ✓ | ✓ | ✓ | ✓ | x |
| Interference | | | | | |
| Coordination | | | | | |
| Load Balancing | ✓ | ✓ | ✓ | ✓ | x |
| Random Access | ✓ | ✓ | ✓ | ✓ | x |
| Process | | | | | |
| Broadcast of System | x | x | ✓ | ✓ | x |
| information on BCH | | | | | |
| Paging | x | x | x | ✓ | x |
| Other RF functions | ✓ | ✓ | ✓ | ✓ | ✓ |
| (e.g., power control, | | | | | |
| timing advance, | | | | | |
| modulation, up- | | | | | |
| conversion, . . .) | | | | | |
| UE measurement | x | x | ✓(FFS) | ✓ | * |
| reporting and control | | | | | |
| the reporting | | | | | |
| NAS signalling | x | x | x | ✓ | x |
| handling | | | | | |
| QoS management | x | x | ✓(FFS) | ✓ | x |
| Mobility function | x | x | ✓ | ✓ | * |
| (hand over) | | | | | |
| L2 functionalities | x | ✓ | ✓ | ✓ | ✓ |
| (PDCP, RLC and | | | | | |
| MAC) except RACH | | | | | |
| RRC connection set- | x | x | ✓ | ✓ | * |
| up and maintenance | | | | | |

The symbol ✓ means that the operation can be performed by the relay type.
The symbol x means that the relay is unable to perform the operation.
The symbol * means that the R-eNB cannot perform the operation on its own. It needs the authorisation from and coordination with the controlling eNB.

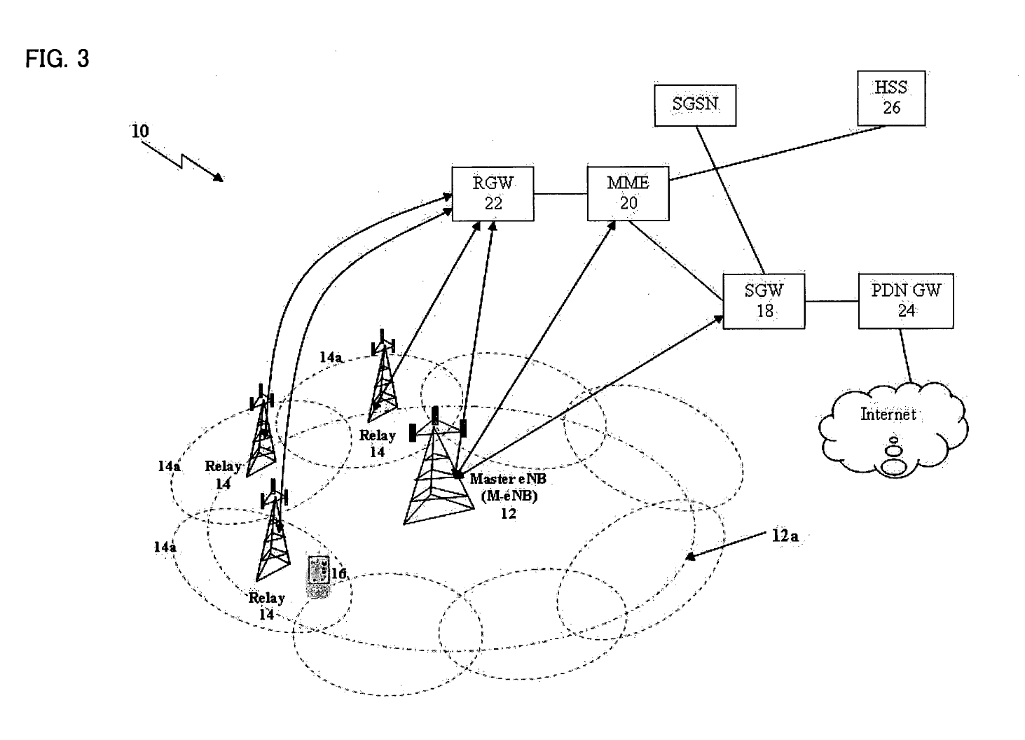

FIG. 3 shows the primary sections of the architecture of the network 10 of the present embodiment. An eNodeB 12 is associated with a cell 12a, said cell 12a being indicated by the dashed line. Three relays 14 are disposed towards the edge of the cell 12a. Each relay is associated with its own sub-cell 14a.

The system further comprises a serving gateway 18, a mobility management entity 20, home subscriber server 26 and a packet data network gateway 24. A relay gateway 22, which is described in further depth below, is also provided. It will be appreciated that the relays 14 are in communication with the eNodeB 12 and the relay gateway 22 only.

A UE 16 is shown in one of the sub-cells 14a. Thus, if a request from the UE 16 is beyond the capabilities of the eNodeB 12 (because, for example, the UE 16 is at the edge of its cell 12a), the eNode B 12 is operable to use the relay 14 to make a connection with the UE 16. While only one UE 16 is shown in FIG. 3, a connection can be made with one or more UEs 16.

In the present arrangement, the relays 14 in the network are operable to operate in a master-slave mode and hence are always associated with an eNB 12 (the node to which the relays are attached is generally termed a Master eNB or M-eNB) when the relay 14 joins the network 10. All relays have an auto-configuration procedure that takes place when a relay 14 attempts to attach to the network 10 as will be explained further below. As part of the attach process, a relevant eNB is chosen to function as the Master eNB 12 to the Relay 14. This attach procedure enables a relay 14 to get itself synchronised with its master eNB 12 in the same way as used by a UE 16 using the Primary and Secondary Synchronisation channels through the main air interface (Synchronisation in time is also possible using either Network Time Protocol (NTP) or IEEE 1588 mechanism).

This Master-Slave relationship between an eNB (ie. Controller) 12 and a relay 14 enables an on demand relaying operation. This involves the eNB 12 being operable to control the status of relay 14. Namely, the M-eNB 12 is operable to activate a relay 14 when data traffic requires relaying (active mode), and to cause said relay to revert to a standby mode when there is no need for its services. Accordingly, power saving advantages are achieved.

The master-slave relationship is limited only to RRM procedures, conventional and new handover operations in the case of a relay 14 that is of type R-eNB only. This means that any relay 14 of this special type is effectively isolated when handling any UE 16 related traffic, as it has a fully functional L2 and has S1-U-like interface with the Serving Gateway 18.

Typically, a relay 14 of type R-eNB does not relay UE data traffic. Instead it performs relaying only for signalling traffic destined for a serving MME 20 (namely RRC and NAS signalling) as it does not maintain an S1-MME-like interface. However, this is generally not the case with RNs as they are typical relays for both u-plane and c-plane traffic. From a radio resource allocation point of view, any relay 14 needs the full support of its M-eNB 12. Relays, which are normally found at the edge of a cell 12a, and do not support many of the eNB functionalities such as system information broadcasting on BCH transport channel only, RACH procedure and paging with an exception of handover measurements taking. UEs 16 do not know the existence of any relay 14 unilaterally—hence, the present relay operation enables relay 14 transparent operation and hence does not expect any change to the way legacy UEs 16 operate.

No UE 16 is, allowed to camp on a relay 14.

Each relay 14 has an ID (similar to eNB ID) for the network 10 to uniquely identify them within the PLMN, and this ID is not for use by any UE 16.

A brief discussion as to how a relay 14 in the present system is operable to change between different states is now provided.

A relay 14 can take three states: IDLE, STANDBY and ACTIVE. A relay 14 maintains only an Y2 interface with its master eNB.

Initial L1 synchronisation of a UE 16 (user terminal synchronisation procedure), broadcast of Master Information Block (MIB) on BCH, paging and RACH process are handled by the master eNB 12 in its service area that includes all of the slave Relays 14 in the cell 12a. Thus the relay 14 does not have to support complex signalling operations, which partly ensures relay 14 transparent and scalable operation.

An explanation about the relay attachment procedure, the state machine of a relay 14 and the related state transitions will now be provided, together with an explanation of how auto-configuration of a relay 14 can be enabled.

A) Relay Network Attachment

Relay States

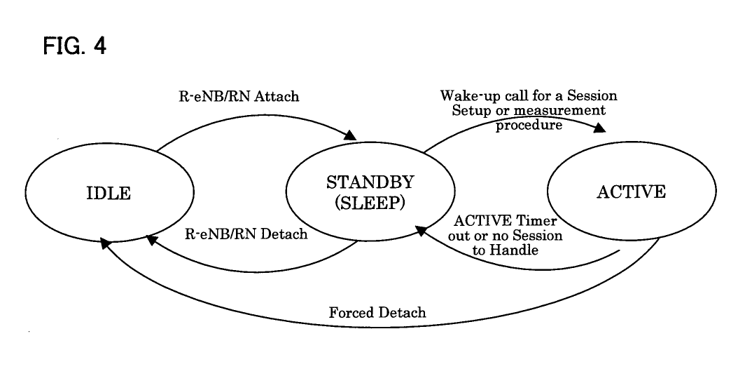

To conserve power and spectrum, the state machine of a relay 14 contains three states that are Relay IDLE, Relay STANDBY and Relay ACTIVE, as shown in FIG. 4. Accordingly to this State machine, Relay IDLE corresponds to a state in which the relay 14 has been powered-on but has not been registered to the network 10. In other words, the relay 14 has not yet been attached to a master eNB (M-eNB) 12. This association takes place as part of the Relay Attach procedure explained below.

Hence, in the IDLE state, neither EPC nor any eNB hold any valid information, such as Relay ID, geographical location and routing (e.g., TAI) pertaining to a relay 14 that is just powered on, and as a result data transmission via the unregistered relay 14 is not possible.

Relay STANDBY is a state in which the relay 14 is registered/attached to the network 10, but is not actually active. Although the relay 14 has been associated with an M-eNB, it is idling in terms of supporting UE related traffic. Transition to this state from an. IDLE state occurs when a relay 14 invokes the Relay Attach procedure, such as R-eNB/RN attach which can consist of the relay joining the network either unilaterally or on receiving a prompt from the controller. The Relay STANDBY mode is a low power consumption mode (ie a sleep mode). In this case the relay is successfully associated with a master eNB (M-eNB), and the relay context will be available to both the master eNB and EPC—but at different granularity level. For instance, it is not required for EPC to know the existence of an RN; whereas in the case of an R-eNB, although the EPC does not need to know the exact geographical location of the R-eNB, it needs the rough geographical location by knowing the tracking area of the R-eNB.

However, the M-eNB 12 needs to know the exact geographical locations of all its slave Relays 14. If the network 10 is capable of acquiring the geographical locations of nodes using GPS, then such is desired, otherwise, the information needs to be entered manually.

The Relay STANDBY state involves relay registration, and so the relay 14 is assigned a unique, temporary, Relay ID by an entity called the Relay Gateway 22 (explained below) after having liaised with the EPC. The Relay ID is similar to an eNB ID. The Tracking Area ID (TAI) of a slave relay, however, takes the same value as that of its M-eNB 12. Each relay 14 thus has three types of information: relay ID, TAI and geographical location. This information of the relays 14 is maintained by their master eNB 12. However, this information does not need to be maintained by the serving MME 20 of EPC for RNs—ie it is only required for R-eNBs.

As will be appreciated, the existence of a relay 14 should not be known to a UE 16 or any other eNBs. Only the direct master eNB 12 knows the presence of the relay. Such a formation allows for the system to be readily included into existing systems.

In the ACTIVE mode, each relay 14 supports user traffic, and associated user plane traffic pertaining to header compression, ciphering, and L2 processing operations such as scheduling, ARQ and HARQ if the relay is an L2/L3 RN or R-eNodeB. Such relays 14 also support control signalling traffic related to MIMO, modulation and coding (using PDCCH, PCFICH and PHICH) for one or more UEs 16 at the request of its master eNB.

Hence, the transition to this ACTIVE state is solely triggered by the master eNB 12 depending on user demands. This can be in the form of a Wake-up call for a Session or a measurement procedure. The M-eNB 12 can wake a slave relay up on a demand basis as long as it was previously in the STANDBY (SLEEP) mode, and unless the relay is already in an ACTIVE state. In case of a service setup or reactivation, the relay 14 is able to switch to relay ACTIVE mode within a short period of time (<50 ms) from the STANDBY state. Although flexibility for relay mobility is not ruled out, it is not considered herein for convenience. However, it is noted that if relay mobility is permitted, the wake-up call will be similar to the normal paging process. In both the STANDBY and ACTIVE states, each relay 14 is synchronised with its master eNB, in the same way used by a UE 16 using the Primary and Secondary Synchronisation channels through the main air interface (Synchronisation in time is also possible using either NTP or IEEE 1588 mechanism). Once successfully attached, STANDBY and ACTIVE are the dominant states of the relay 14.

Relay Self-Configuration

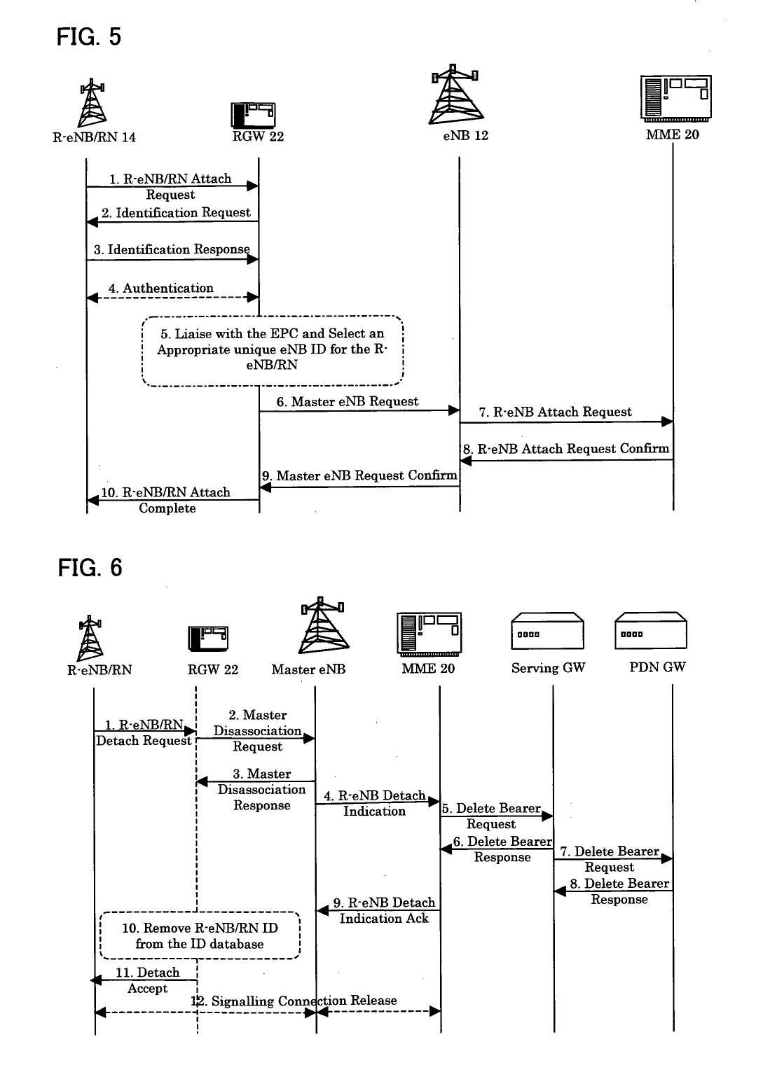

Given that in a network 10 there will generally exist many relays 14, connecting them directly to the EPC may create scalability problems and pose security threats. Hence, it is optimal to connect the relays 14 to EPC via a Relay Gateway (RGW) 22. This RGW 22 can be a software implementation housed in an MME 20. The RGW 22 serves the purpose of functioning as a firewall and more importantly has the repository to find out the appropriate master eNB 12, if geographical location information of a relay 14 is acquired. An example of relay configuration is now provided with reference to FIG. 5.

If the RGW 22 determines that a given relay (say, R1) is located within the geographical area served by a controller (say, eNB-1), then eNB-1 is chosen by the RGW as R1's master eNB. Once decided, the relevant information is passed to both the selected master eNB and the relay. In this way, the relay gateway is operable to assign the relay R1 to the controller eNB-1. Once confirmed, the master eNB will identify the appropriate MME 20. In addition, the RGW 22 performs the task of assigning a unique, temporary eNB ID (identification) to every newly attached relay. It liaises with the relevant EPC entities to assign a unique eNB ID to each successfully registered relay and updates the centralised database (repository) that contains the ID information of all network nodes such as MMEs and eNBs. This eNB ID assigned to the successfully registered relay is termed Relay ID for clarity, although it is the same as an ordinary eNB ID. The relevant relay context information will be stored in the M-eNB and the serving MME 20 (only for an R-eNB) until the relay's state is switched to IDLE.

The newly introduced relay follows Home-eNode B principles in terms of the way it auto-configures itself. For this to happen, each relay 14 needs to be provided with at least a valid IP address and a working interface. As part of the Relay Attach procedure, a relay 14 will then use hard-wired (default) parameters along with its International Relay ID (IRID), which is similar in principles to International Mobile Subscriber Identity (IMSI) to establish an SCTP association across the interface to enable it to make contact with a RGW 22. This IRID is stored in a SIM-card like smartcard to be associated with every relay 14.

Relay State Transitions

This depends on the current state and, the event that occurs.

Moving from IDLE to STANDBY Mode:

A successful Relay Attach is shown in FIG. 5. This process will lead to this state change. Through this process each relay 14 finds and associates itself with an appropriate master eNB 12 and gets itself assigned a valid eNB ID (termed Relay ID) with the help of the RGW 22.

Moving from STANDBY to ACTIVE Mode:

A successful wake-up call and a subsequent session-setup request or a dedicated measurement initiation request (as part of the Relay Selection Algorithm—see below) by the master eNB 12 will lead to this state change. In order to facilitate these operations, a new set of handshake procedures between an existing master eNB 12 and its slave Relay 14 is provided.

Moving from ACTIVE to STANDBY Mode:

The relay 14 comprises a timer device. Once a relay 14 enters an ACTIVE state, the timer starts a count down, and in case there is no activity in terms of user traffic or associated user plane traffic such as header compression, ciphering, scheduling, ARQ and HARQ by the relay before it is timed-out (predetermined time of non-use), the relay will switch to the STANDBY mode. This allows the relay 14 to conserve power if it is not required.

Moving from STANDBY to IDLE Mode:

A relay detach process leads to this state change. Either the relay or EPC (mainly an MME 20 in the case of an R-eNB only) triggers this state transition, and this will result in the deletion of associated context information maintained by both the master eNB 12 and serving MME 20 (only in the case of an R-eNB)—preferably after a certain (implementation dependent) time. The RGW 22 is notified in order for it to update the centralised network node ID table.

Moving from ACTIVE to IDLE Mode:

A forced Relay Detach process leads to this state change. This happens when the network (mainly the serving MME 20 in the case of an R-eNB only) dictates that a given relay 14 should be disconnected from the network 10. The RGW 22 needs to be notified to update the centralised network node ID table.

Relay Attach Procedure:

A relay 14 is operable to initiate the attach procedure by the transmission of a relay Attach Request giving the IRID, classmark, DRX parameters and geographical location information to the RGW 22. Classmark contains the relay's 14 supported LTE ciphering algorithms in addition to the other existing classmark parameters defined for LTE. DRX Parameters indicates whether the relay 14 uses discontinuous reception or not, and such information along with the eNB ID of the relay 14 has to be passed onto the chosen M-eNB 12 as part of the attach process (operation 6 of FIG. 5). If the relay 14 uses discontinuous reception, then DRX Parameters also indicate when the relay 14 is able to receive wake-up requests by the M-eNB 12.

The RGW 22 coordinates with the EPC to assign a unique eNB ID to each newly joining relay and performs the identification, AKA Authentication and ciphering associated with relays 14. It does not maintain any state information related to any relay 14. Operations 7 and 8 of FIG. 5 are necessary only for R-eNBs and are not required by any newly attaching RN. However, the eNB ID of each detached relay 14 should be notified to the RGW 22 that will in turn liaise with the EPC to remove the eNB ID from the centralised node ID database. The equipment checking functions are defined in the clause “Identity Check Procedures”, although equipment checking is optional. As part of this attach procedure, a relay 14 uses the same mechanisms as adopted by a UE 16 to synchronise with its M-eNB 12 using the LTE air interface.

In the case of a relay 14 of R-eNB type, the following measures are taken. This is because an R-eNB has an S1-U-like interface with the core and is able to have an EPS bearer tunnel setup via a relay by-passing the M-eNB 12. If there are active EPS Bearer contexts being setup via the R-eNB (and hence has a valid Relay ID) in question and it tries to re-attach to the network 10 without having properly detached before, the new Serving GW 18 has to delete these EPS Bearer contexts by sending Delete EPS Bearer Context Request (GTP TEID for the GTP-U tunnel over S5 interface between a given Serving GW 18 and PDN GW 24 pair and a Serving GW 18 and a relay pair, and LCID for the Uu interface Radio Bearer between a given relay 14 and UE pair) messages to the PDN GWs involved. The relevant PDN GWs 24 need to acknowledge with Delete EPS Bearer Context Response messages. If the original attach procedure fails, the relay 14 should re-initiate after a time-out. Further, Automatic Device Detection (ADD) function can be supported by the RGW 22 so that this network association process can be initiated by the RGW 22.

Relay Detach Procedure:

This procedure can be initiated by either a relay 14 or the network 10. Only the attached relay 14, which has been assigned a unique eNB-ID (referred to here as Relay ID) and already associated with a master eNB 12, can be detached. In this process, the RGW 22 is involved because it needs to liaise with the EPC to remove the associated Relay ID from the centralised network node ID database. The Detach procedure when initiated by the relay 14 is illustrated in FIG. 6. In this case NAS-like Relay Detach Request message along with IRID and TAI+ECGI of its master eNB 12 is sent by the relay 14 in question to the RGW 22. The master eNB 12 will subsequently be notified about the relay's decision using the TAI+ECGI information being passed onto, and will thus let the master eNB 12 of the relay 14 in question relinquish its role as the master for that particular relay 14. In this process, the relay context information maintained by network nodes such as the master eNB 12 and MME 20 will be removed.

The following operations (as shown by (4), (5), (6), (7), (8), (9) and (12) in FIG. 6) only apply to R-eNBs, and hence are not relevant to RNs. Given that an R-eNB maintains an S1-U-like interface, in the case of R-eNB (and not any RN) the serving MME 20, through collaborating with the relay's master eNB, will deactivate the active EPS Bearers in the Serving GW18, if any, established and maintained specifically for this particular R-eNB by sending Delete Bearer Request (TEID) to the serving GW 18. The serving MME 20 has to collaborate with the master eNB 12, as from L1 perspectives the relay functions as a remotely located antenna array of the master eNB 12 and hence the Radio Bearer allocation is still handled by the master eNB 12. If Standby-mode Signalling Reduction (SSR), which is similar in principles to Idle-mode Signalling Reduction (ISR), is activated, the serving GW 18 deactivates this and acknowledges with Delete Bearer Response (TEID). If SSR is activated, the serving MME 20 sends Detach indication (IRID) message to the associated Serving GW 18. Serving GW 18 has to delete these EPS Bearer contexts by sending Delete EPS Bearer Context Request (GTP TEID for the GTP-U tunnel over S5 interface between a given Serving GW-PDN GW pair and Serving GW-Relay pair, and LCID for the Uu interface Radio Bearer between a given relay and UE pair) messages to the PDN GWs 24 involved. The relevant PDN GWs 24 need to acknowledge with Delete EPS Bearer Context Response messages. Network initiated detach process also works in the same manner, but the relay Detach Request message is initiated by the RGW 22 or, only in the case of an R-eNB, the serving MME 20.

B) Master-Slave Operation

The on-and-off relaying operation enabled through the Master-Slave relationship between an eNB 12 and a relay 14 is briefly explained in this section with a simple scenario. Assume that there is an UE 16 in the eNB's coverage area (such as located in overlapping service regions of controlling, first and second nodes) that is located at the edge of the cell 12a, and further assume that it is going to initiate a high bandwidth greedy multimedia application that requires bit rate in the order of 500 Mbps both in downlink and uplink. A UE 16 is only allowed to camp on eNBs, such as M-eNB (controlling node). This is because it is reasonably believed that a camping on process does not necessitate high bandwidth, and hence a UE 16 can still be comfortably supported by an M-eNB for these procedures irrespective of UE's locations (except dead spots, which are not considered in the present application). Accordingly, using the synchronisation channels, the IDLE UE, which is located at an edge of the cell 12a, will get synchronised with the master eNB 12 in time, frequency and phase. Once synchronised, the UE 16 will listen to the BCH for the purpose of gathering information namely the cell-ID and RACH preambles pertaining to the master eNB it is camping on. Then using RACH together with RRC Connection Reconfiguration, the UE 16 will try to invoke (initiate) a NAS: Service Request that involves user registration, authentication procedure (AKA) and initial context setup—again via the master eNB and no relay has played any part till now. Given the location of the considered UE 16 and its strenuous QoS requirement, on seeing that the measured signal strengths at both the UE 16 and the master eNB 12 are poor to support the required bit rate, the M-eNB 12 will quickly decide to get the neighbouring relay to take care of a given UE's traffic (i.e., both the UE traffic and associated user plane and control signalling traffic). In other words, on receiving the service request, the M-eNB 12 (controlling node) is operable to examine a request for a wireless communication session from the user terminal. This is where a relay comes into the picture, and the M-eNB 12 will coordinate with all the relevant nodes to ensure a seamless UE switchover process (comprising a novel type of handover called “Switchover” which is described hereinafter). The Relay selection algorithm run by the M-eNB 12 is responsible for the appropriate (optimal) relay selection, and it has two stages. The selection decision is based on location and measurements taken by neighbouring cells—the latter is again coordinated and controlled by the M-eNB 12. Once the chosen relay 14 has been instructed to support a given UE traffic, the master eNB 12 will not maintain direct interaction with the given UE 16; instead it will interact via the serving relay 14 only for RRM and handover/switchover related operations. An advantage of this Master-Slave strategy is that until a relay 14 has been instructed by its master eNB 12 to take care of a given UE traffic, it can sleep (i.e., by switching to STANDBY sub-state) as long as it does not support any UE 16 at all. In other words, when a relay 14 is in ACTIVE state, it runs a SLEEP timer whenever a RLC SDU traverses, and in case there is no more RLC SDUs before it times out, it will switch to its STANDBY power-saving mode.

The extent of the Master-Slave operation between an eNB 12 and a relay 14 is thus limited to tasks very similar to the radio resource management related procedures, initial UE communication setup if relay's 14 involvement is necessitated by its master eNB 12, and handover and new switchover operations. In the case of an R-eNB and a L3 RN, the task of radio resource allocation and configuration by the M-eNB 12 is easy and is very similar to the already existing mechanism with minor changes due to the availability of RRC and RRM procedures. On the other hand, in the case of a L1/L2 RN, similar tasks require a number of handshakes between the M-eNB and the relay via an Y2 interface.

A relay 14 does not own any radio resource, and hence it needs to be dynamically assigned and configured radio resources by its M-eNB 12 when the relay 14 needs to serve a given UE 16 on a demand basis. Once allocated, a given relay 14 of type R-eNB can support the given UE 16 in a standalone manner, given the fact that an R-eNB maintains necessary interfaces with its master eNB 12 and the EPC like the way a normal eNB does (but no S1-MME like interface for simplicity). However, this is not the case with any RN as it is required to really relay even the UE traffic. Accordingly, for the reasons mentioned once resources are configured, a standalone operation in terms of supporting a given UE traffic is possible for any relay 14 of type R-eNB only. On the other hand, for an UE switchover or handover operation and for most of the RRM and RRC related operations including dynamic Radio Bearer reconfiguration, transport channel reconfiguration or physical channel reconfiguration (possible through relevant RRC procedures like RRCConnectionReconfiguration, radioresourceConfiguration, RRCConnectionRelease), a relay 14 has to interact with its master eNB 12.

The present invention allows for the master eNB 12 to adaptively allocate radio resources on a demand basis to both relays 14 and UEs 16. In this case, the relay 14 can be viewed as a radio access node.

In wireless mobile communications, a semi-centralised decision making with regard to radio resource allocation can lead to the avoidance of resource allocation clashes, low interference, efficient usage of radio spectrum and better Quality of Service support. To exploit this, in the present arrangement, each M-eNB 12 owns and controls resources within its cell 12a and allocates/configures/modifies/releases radio resources in a centralised way to its slave relays 14 on a demand basis. Using the previously described Master-Slave operation enables an M-eNB 12 is operable to control the state of a relay 14, centralised resource allocation can additionally bring in such benefits as soft frequency reuse, spatial multiplexing and easy adoption of MU-MIMO.

Given that the Master eNB 12 has sound knowledge as to when to get a relay 14 to support given UE related traffic and the UE's QoS requirements, it can allocate, assign and configure the radio resources from its common pool.

As a relay 14 does not own any radio resource, it needs to be dynamically assigned radio resources by its M-eNB (i.e., Resource Block assignment by its master eNB 12 on a demand basis). This granularity of the radio resource allocation can go to the extent of Resource Element (RE). In addition, L1 radio bearer (RB) allocation by the Master eNB 12 to any of its slave relays 14 is very similar to the conventional RB allocation by an ordinary eNB to a UE. From this RB allocation perspective, the M-eNB's functionality is similar to that of an ordinary eNB—and this is the same from UE's point of view. The only minor difference is that once allocated, the M-eNB 12 does not listen to those RBs unlike the way it does it for the UEs 16 it directly supports (i.e, allocation is the same but the usage pattern is slightly different). Given the availability of RRC, in the case of R-eNBs and L3 RN, this type of resource allocation by the M-eNB can be implemented with minor modifications. In the case of an R-eNB, once an R-eNB has started serving a UE 16, the M-eNB 12 does not carry the traffic of the given UE 16 as the EPS Bearer tunnel is established directly via an R-eNB by-passing the M-eNB. On the other hand, in the case of L1/L2/L3 RN, the UE traffic and associated control signalling is relayed—however, the given UE is served by the M-eNB via a relay.

The resource allocation is similar to conventional UE 16 resource allocation for R-eNBs and L3 RNs given that they have a lightweight RRC feature. L1 and L2 relays do not have any RRC feature, and hence an interpreter that translates the RRC/RRM configuration messages from the M-eNB 12 and passes them onto the MAC sub-layer (applicable only to L2 RN) and to the physical layer of a RN in the required format is used. This can be possible by having an interface (Y2) between a RN and its Master eNB 12 and configuring the resources via this interface using an augmented application protocol. Similarly, almost all RRM related procedures are fully controlled and coordinated by the M-eNB 12 with minor modifications in the case of R-eNB and L3 RN and with an augmented Y2 interface in the case of L1/L2 relays.

Once a successful switchover (see below) has taken place, R-eNB forwards the L3 (especially NAS) signalling traffic to M-eNB through Y2 interface to be forwarded to its serving MME 20, while sending the UE 16 related traffic directly to its serving GW 18 via the S1-U-like interface. The RN, on the other hand, forwards both the u-plane and c-plane traffic via the M-eNB. The UE traffic switchover is possible with the master eNB 12 performing a RRC Connection Re-configuration, while making both the source and target R-eNBs or L3 RNs ready for the switchover and coordinating the establishment of the required traffic tunnel via the target R-eNB. Once this is done, the UE and the target R-eNB/RN will continue using the physical resources allocated by the master eNB exclusively for supporting a given UE traffic until the session is terminated or handed over to a different master eNB or switched over to a different relay belonging to the same master eNB 12 or radio release due to UE's inactivity (idling) or bearer reconfiguration in accordance with the changing QoS requirement.

In a mobile network, the UE 16, by definition, is mobile. Hence, it is often required for a UE 16 to be passed from one node to another.

In the present case, the following principles apply to all types of relays, including R-eNBs, and other relays hereinbefore described. However, a few exceptions apply. Thus, in the following description, the term ‘relay’ is used to refer to all types of relays. If a specific relay is meant, it is classified by name. The term RN is used to refer to all types of relay except R-eNBs.

In the case of R-eNB, routing often involves selecting the appropriate R-eNB as part of handover and/or switchover and setting up the EPS Bearer tunnel directly via the R-eNB bypassing the M-eNB. On the other hand, in the case of an RN, routing involves only the selection of an appropriate RN as part of handover and/or switchover operations, as an RN is a typical relay. The fact that any R-eNB is directly connected to the EPC via an S1-U-like interface enables the possibility of establishing necessary traffic tunnels (EPS Bearer) between a PDN GW 24 and an. UE 16 via the R-eNB that does not necessarily include the M-eNB 12. The M-eNB is responsible for determining and controlling when the services of a relay is needed based on measurement results and QoS requirements of a given UE 16, and coordinating the full switchover/handover operations. Hence, this optimal traffic routing involves the following operations:

1) Switchover/Handover Measurement procedures;

2) R-eNB/RN Selection Algorithm; and

3) EPS Bearer tunnel establishment via an R-eNB by-passing the M-eNB.

Switchover/Handover Measurement Procedure

Irrespective of whether a NAS Service Request to initiate a session demanding a very high bandwidth is triggered by a UE 16 or the network 10, the M-eNB will initially be involved in the communication session setup. This feature enables relays that currently do not support any active UE to sleep. Hence, as mentioned before initial camp on process by any UE is on the M-eNB (the controlling node), and in order to ensure this, the present invention does not consider a situation where relay is employed to extend the coverage area.

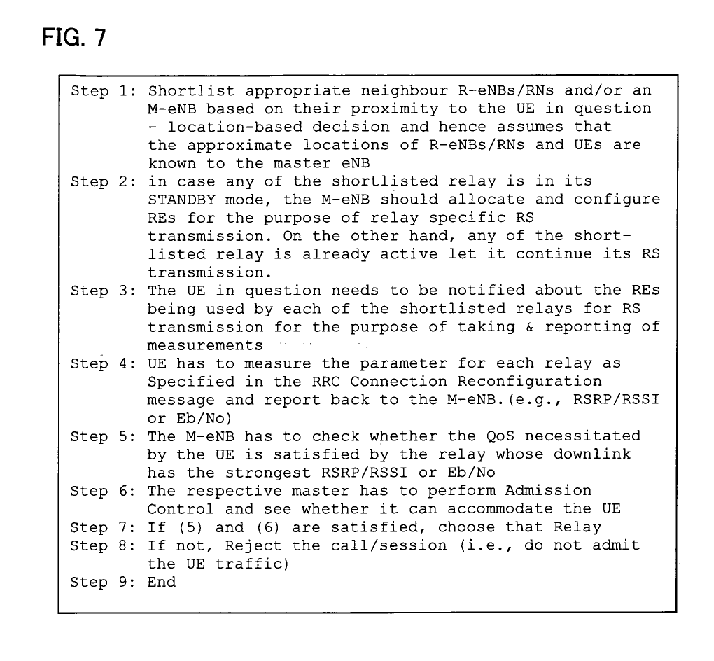

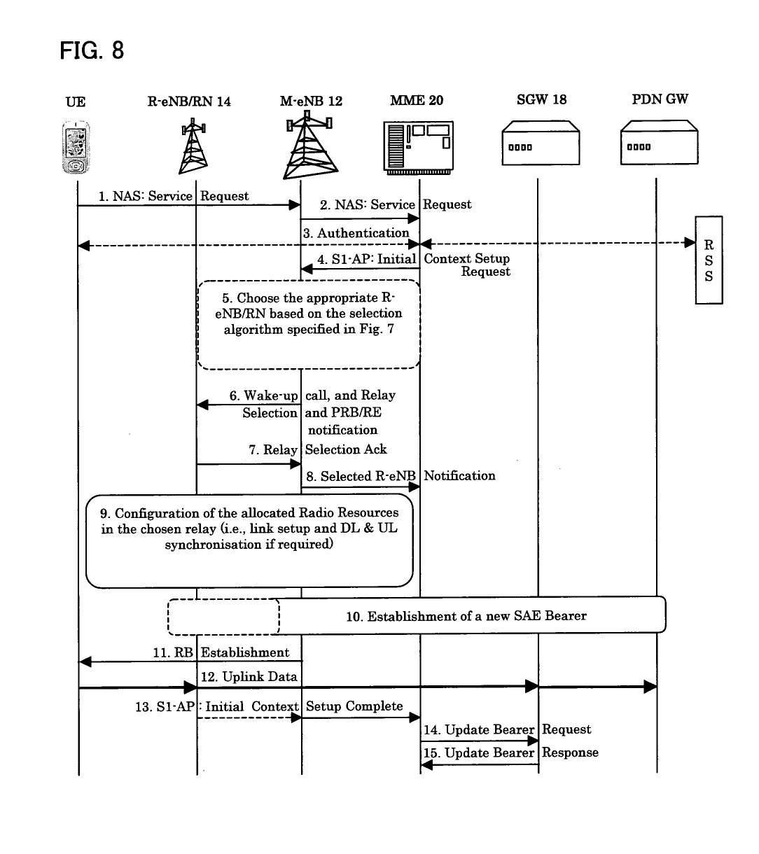

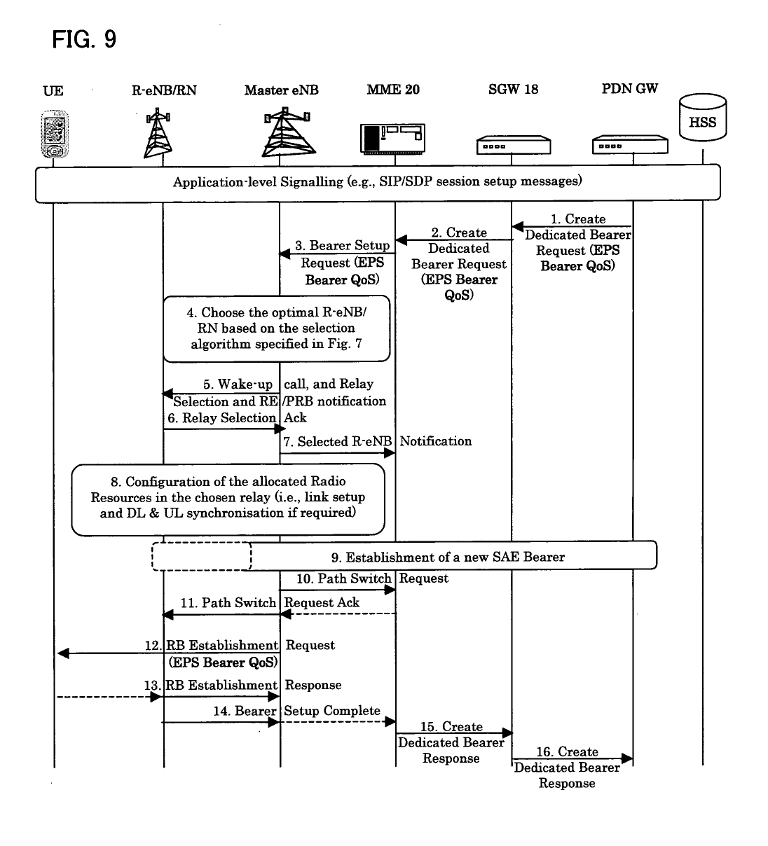

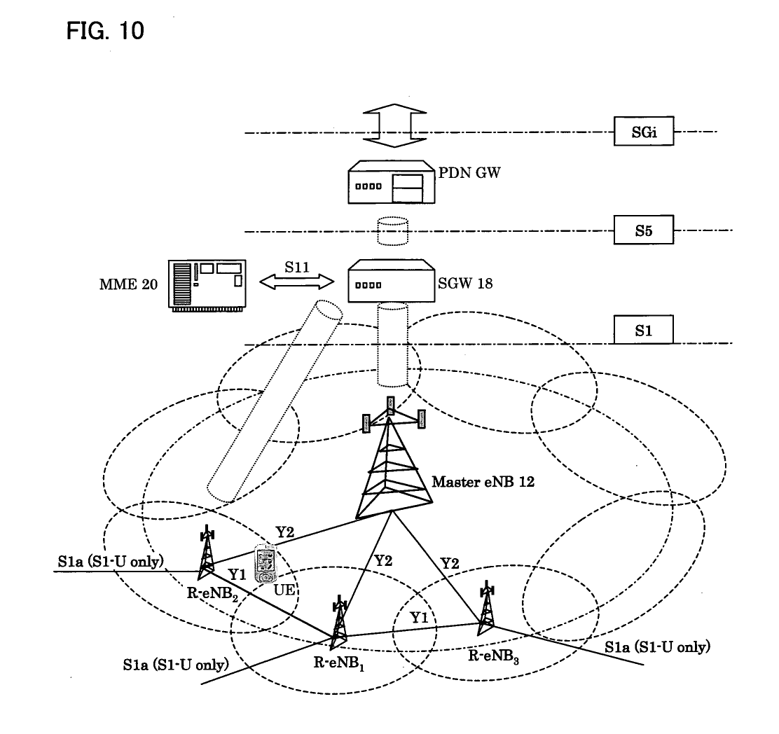

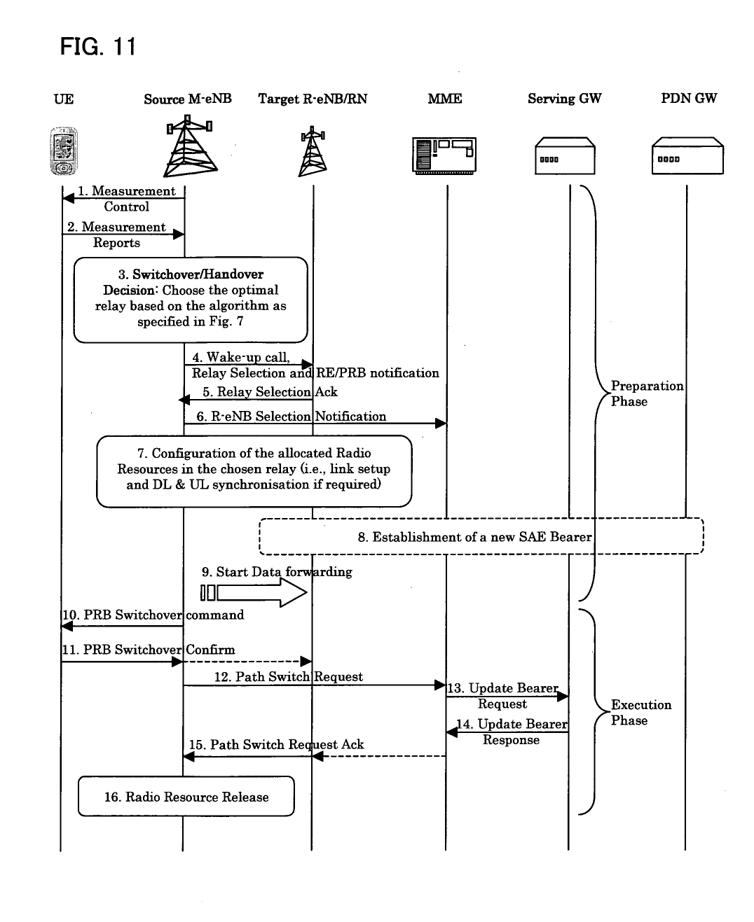

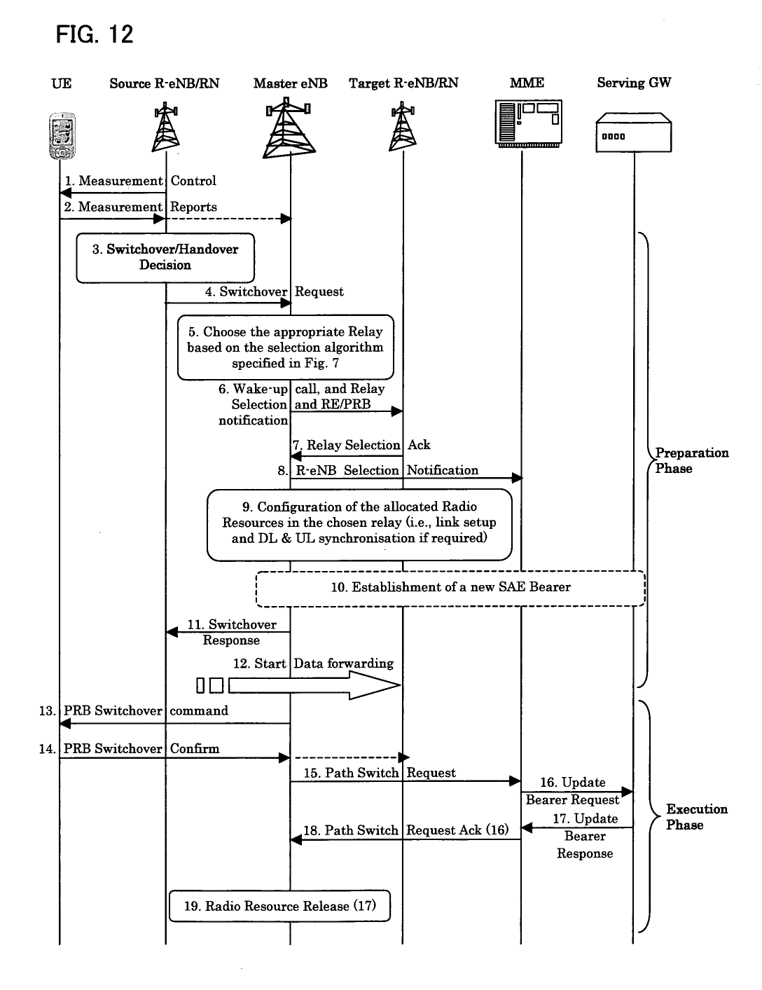

As described previously, the UE 16 is operable to camp on the M-eNB (controlling node) and to subsequently initiate a NAS service request. Accordingly, on receiving the NAS service request, the M-eNB is operable to examine a request for a wireless communication session from UE 16. This is achieved from the dedicated measurement reports by the UE in question. If the M-eNB determines that it cannot support the UE traffic, the M-eNB needs to consider handing over the data-traffic of the UE in question to the appropriate relay or any other eNB that is located very close to the UE in question. For this purpose, the M-eNB will first select the most appropriate relay 14 or any eNB by running the Relay Selection algorithm shown in FIG. 7. Once an optimal relay is chosen, the M-eNB will allocate and configure the required radio resources at the chosen relay prior to the traffic switchover/handover—this is one of the features that distinguish the switchover from handover (other features are tabulated in the section “Switchover vs. Handover” described later in the description).

The selection algorithm runs in two stages. In the first stage, the M-eNB 12 has to establish a shortlist of potential nodes/relays 14 which are located close to the UE in question. This may sometimes require the M-eNB to seek the assistance of relays belonging to neighbouring M-eNBs.

Whenever a relay 14 supports a given UE session, it needs to send cell specific (i.e., relay specific) RS on the required resource elements within the RBs being allocated/configured for the down link of the relay 14 to support a given session of a UE 16. If the shortlisted relays 14 are already active, the M-eNB 12 will request the UE 16 in question to take measurements of the RSs pertaining to the shortlisted relays and to report back to the M-eNB 12. This is possible by notifying to the UE 16 the shortlist and specifying as to when the UE is required to take measurements of operating parameters pertaining to each relay 14. An RRCConnectionReconfiguration message is used to convey the information to the UE in question.

Given that it is the M-eNB 12 that allocates and configures radio resources of each relay 14 within its domain, the M-eNB will have sound information as to the REs being used for RS transmission of each shortlisted relay and their ID. This ID does not need to be a physical layer cell ID, as the relay will not use this ID for any purpose other than including this ID in the RS to let a UE, which is instructed by its M-eNB, take measurements for switchover/handover purposes. However, this ID can belong to a physical layer cell-identity group which the M-eNB 12 uses in its cell 12a, and the M-eNB can dynamically assign this ID to its slave relays on a demand basis. In case any of the shortlisted relays belongs to a neighbouring M-eNBs, then the current M-eNB has to communicate with the respective M-eNBs of the neighbour cell to receive information regarding the REs being used by those relays for RS purposes and the relay IDs being included in the relays' RSs. If, on the other hand, any of the shortlisted relays is in its STANDBY mode, they need to be woken up by their respective M-eNBs. Furthermore, their M-eNBs should allocate and configure REs for the purpose of transmitting the relay-specific RSs. This needs to be facilitated through the respective M-eNBs, if a shortlisted relay belongs to a neighbour cell. This measurement taking process will not, however, impair the transparent operation of the relays, as it is the M-eNB that passes the information regarding the REs and relay specific ID being present in its RS pertaining to each and every shortlisted relays onto the UE 16 in question. In other words, UEs do not have to unilaterally listen to the relay-specific RSs that are mostly transmitted for a short duration for taking measurements unless a given relay 14 is actively supporting more than one UE 16 already. In addition, it is preferable to take measurements in the uplink as well. For this purpose, the respective Master eNB 12 can instruct the UE 16 in question to perform UL Sounding after having allocated the necessary REs, also instruct the short-listed relays to measure it and report it back as a measurement report to the M-eNB 12. Based on the measurement reports from both the UE and short-listed relays, the M-eNB 12 can decide as to which relay is most suitable (optimal) in order to satisfy the QoS demanded by the UE 16.

Once the relay 14 is chosen to support a given UE 16, other non-selected shortlisted relays are arranged to stop transmitting RSs if they are not currently serving a UE, and can subsequently switch to the SLEEP state.

Relay Selection Algorithm

An M-eNB 12 runs a relay selection algorithm to choose optimal relays for switchover and/or handover, to allow for optimal routing. The relay selection algorithm is specified in FIG. 7.

The algorithm has two stages before the final decision as to the suitability of a relay is made. In the first stage, the algorithm shortlists only the relays that are physically located very close to the UE 16 in question, and hence it is often based on the locations of both its own slave relays and other relays belonging to different master eNBs 12, and the UE 16 in question. The objective is to find the very closest relay to support the UE traffic. However, there may be situations where far-away relays can best support the demanded QoS of a given UE—this is why, in the second round of the decision making process, the final selection is made by the measurements taken by the UE in question under the instructions of the master eNB 12. Once the relay 14 is selected after the second stage is complete, the M-eNB 12 performs the admission control for its slave relay, such that the M-eNB allocates resources dynamically from its common pool, and assigns/configures that L1 resources for an exclusive use by the chosen relay in order to support the given UE traffic.

In certain scenarios, it may be optimal to seek the assistance of relays that belong to the neighbour eNBs. Hence, the current master eNB 12 can communicate with the neighbouring master eNBs, and coordinate with them to send the required RS for the UE 16 in question to take measurements. This will help the current master eNB of the UE 16 in question to ascertain as to which relay can comfortably support the bit rate required by the UE's application.

Master eNBs do not communicate directly with relays that do not belong to their cell.

A M-eNB 12 communicates with its relevant neighbours via the X2 interface and passes the geographical location information of the UE 16 in question onto them. Having known the geographical location information of the UE in question, other neighbouring M-eNBs are able to choose the appropriate relays belonging to them. Once chosen, the respective neighbour M-eNB is responsible for waking the chosen relay 14 up, in case the latter is in its SLEEP mode, getting the relay to initiate transmitting RS unless the relay is already active, and passing the RE information of the RS transmission and relay ID along with the relay-specific ID being used in RS to the requesting M-eNB.

EPS Bearer Tunnel Establishment

In the case of a traffic switchover within a cell (i.e., a handover between the M-eNB 12 and one of its slave relays 14), EPS Bearer tunnel establishment is needed only for an R-eNB once the first two procedures are complete. This is because an R-eNB maintains an S1-U-like interface, hence it does not need to backhaul the UE traffic to/from the M-eNB 12. The M-eNB knows when a given UE traffic needs to be switched over to a relay 14. When the relay is an R-eNB, the M-eNB will perform an extra task of coordinating with the MME 20 to establish the EPS bearer tunnel directly via the R-eNB by-passing the M-eNB 12. This is in addition to M-eNB's tasks of allocating and configuring the radio resources for the exclusive use by the R-eNB in order to support a given UE traffic session. Once these two operations are complete, a seamless switchover operation will be ensured by the M-eNB 12. This will allow the R-eNB to support the given UE 16 in a very standalone fashion, given the fact that an R-eNB has a fully functional L2 (especially MAC) and maintains interfaces with the Serving Gateway 18 (but not with the MME 20) like the way a normal eNB does. Hence, with this arrangement user plane latencies can be brought down. This is not the case with any RN from a routing perspective.

The following subsections discuss relay selection and how routing (i.e., handover) is performed with various categories of relays under different circumstances.

UE Communication Sessions

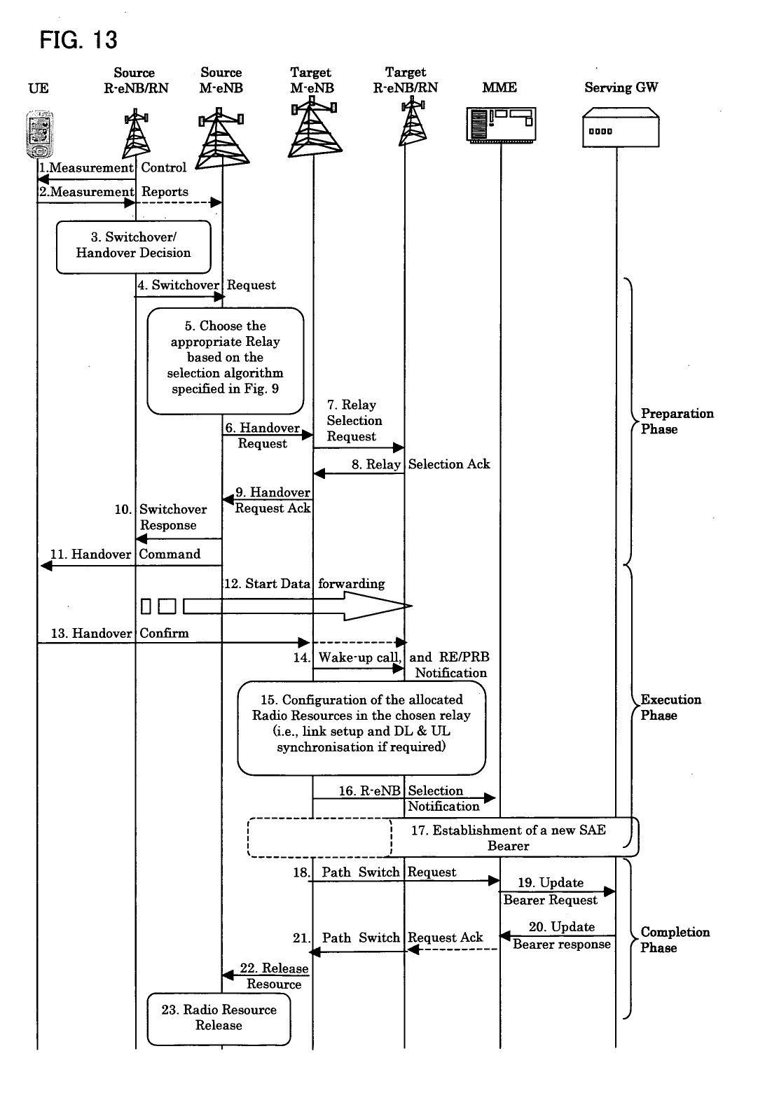

The different phases involved in a communication session setup by a UE 16 in a network 10 that comprises relays 14 is described here with reference to FIGS. 8 and 9.

Assume that the subscriber terminal UE 16 is already switched on and successfully registered to a PDN network 10. FIG. 8 illustrates the sequences involved in an E-UTRAN comprising of relays 14 when a user initiated a service request. This sequence of messages occurs when, for example, a UE at the edge of a cell 12a in IDLE mode initiates a high bandwidth demanding multimedia enriched gaming application. The whole process results in a transition of the UE from an IDLE state to an ACTIVE state. The network-triggered Service Request looks exactly the same. The only difference is that the Service Request is triggered by the reception by the terminal of a paging containing its identity.

To initiate the service, the UE 16 sends a Service Request NAS message to the MME 20 using the Random Access procedure. Given that relays do not support RACH procedure, the master eNB 12 is involved initially in this Session Setup. Then using RACH, together with RRC Connection Reconfiguration, the UE 16 will try to invoke a session setup that involves user registration, authentication procedure (AKA) and initial context setup. Initially the default bearer, which is a non-GBR bearer, may have been established between the UE 16 and the master eNB 12. When the M-eNB receives the initial context setup request from the serving MME 20 (operation 4 of FIG. 8), the M-eNB 12 may decide that it is not able to support the QoS requirements of the given UE 16 directly. This may be because of the current location of the given UE and its strenuous QoS requirements, and on seeing that the received RSRP at a given UE 16 is too low to support the demanded application (i.e., signal strength is poor), the M-eNB 12 may decide to cause a relay to handle the given UE related traffic (i.e., all user traffic, associated user plane traffic such as header compression, ciphering, and L2 processing operations such as scheduling, ARQ and HARQ only if the relay is an L2/L3 RN or R-eNB, and control signalling traffic related to MIMO, modulation and coding (using PDCCH, PCFICH and PHICH). The M-eNB 12 will make an attempt to choose the most appropriate relay, and notify the allocated PRBs/REs to the chosen relay.

The above message sequence is common to any type of relay 14 (i.e., RN and R-eNB), and the present embodiment is a common illustration for both R-eNBs and RNs. However, some operations are specifically required for R-eNBs and may not be applicable to an RN or vice-versa. For instance, the decision about the relay selection has to be notified to both the relay and to the MME 20 only in the case of the relay being an R-eNB—i.e., operation 8 of FIG. 8 is not required by an RN. In the case of an R-eNB, this process ensures that the required tunnel will be established from the PDN GW 24 to the chosen R-eNB—note that this tunnel will not include the M-eNB. On the other hand, in the case of an RN, the EPS bearer is established via the M-eNB, as the relay is a typical relay. Accordingly, operation 10 of FIG. 8 has a broken line connecting the relay. Once achieved, the M-eNB will allocate and configure the RB resources on the air interface between the relay 14 and UE 16. The M-eNB 12 will perform this through Radio Bearer Procedures in the case of L3 RN and R-eNB. In the case of L1/L2 RNs, similar procedures are facilitated with an augmented interface between the relay 14 and the M-eNB 12. From the Physical layer perspectives, the relay 14 will function as a remotely located antenna array (of the M-eNB) that will use the REs/PRBs according to the instructions given by the master eNB. This will be followed by the transmission of u-plane and c-plane traffic through the established EPS Bearer. Given that every R-eNB maintains an S1-like interface (only S1-U) with the EPC, once the given UE user traffic and associated user plane traffic such as header compression, ciphering, scheduling, ARQ and HARQ is taken care by the chosen R-eNB (it is not regarded as a typical hand-over, but a Switchover) the master will not continue supporting the given UE traffic (both u-plane and AS c-plane)—but supports NAS signalling continuously. On the other hand, in the case of an RN, the master eNB should continue transmitting both the u-plane and c-plane traffic pertaining to a given UE session.

The MME 20 does not make a direct Initial Context Setup to the relay 14 without first interacting with the M-eNB 12 as shown in FIG. 8 because not every user-traffic needs to be handled by the relay, and the relays are transparent to the UE 16. The M-eNB 12 has the knowledge of signal and load conditions in its cell 12a, and only when it is unable to support a bandwidth greedy application does it require one of its slave relays to handle UE traffic. The core network 10 does not possess the knowledge to trigger such operations directly without communicating with a master eNB—hence, it is optimal for the whole process to be handled by an eNB for scalability reasons.

Suppose that all UE traffic is initially handled by an M-eNB, and in the middle of an ongoing session UE 16 initiates another multimedia enriched session. As depicted in FIG. 9, on realising that a given M-eNB 12 is not able to support the QoS requirements demanded by the UE's new session (perhaps because the UE is located at the edge of the cell 12a), the M-eNB 12 will use a relay Selection algorithm with an objective to choose the most appropriate relay 14. Once a particular relay 14 has been chosen as the possible candidate to support a given UE 16, the M-eNB 12 will communicate with that relay. If the chosen relay is in its STANDBY mode, it is woken up by the M-eNB. At the same time, the M-eNB will notify the relay 14 of the REs/PRBs details that the latter has to use in order to support the UE traffic. Once it is confirmed by the chosen relay that it can support the required bit rate, the relay sends a positive signal back to the M-eNB 12 (operation 6 of FIG. 9).

The physical radio resources need to be configured at the relay 14 by the M-eNB 12 as shown by operation 8 of FIG. 9. At this stage it is important for the relay 14 to synchronise (both in the downlink and uplink) with the M-eNB 12.

If a R-eNB is used, the M-eNB will have to notify the serving MME 20 about the R-eNB selection (as shown by operation 7 of FIG. 9) so that the serving MME 20 can coordinate setting up the EPS Bearer tunnel between the PDN GW 24 and the UE 16 via the chosen R-eNB. This tunnel will not include the M-eNB 12. This strategy will improve the latency—the main problem associated with the usage of real relays. In the case of an RN, the SAE bearer is established between the M-eNB and PDN GW 24.

In the envisaged EPS network comprising the newly introduced relays, an ACTIVE UE has to be first synchronised with the M-eNB covering the cell 12a. This is because it is the M-eNB that allocates the required physical layer resources from within its resource-pool and assigns/configures them to the chosen relay 14 for its exclusive use for supporting the given UE traffic. Once the UE session is over, the resources will be taken back by the M-eNB 12. Hence, it is clear that relay do not have their own radio resources assigned on a permanent basis. If each M-eNB 12 is synchronised with the its own slave relays, which are in their ACTIVE or STANDBY states, it is reasonable to assume that all that is required from the UE 16 is to get itself synchronised with the M-eNB, and hence, it will be automatically synchronised with the chosen relay 14. This is true because from L1 perspectives each relay 14 is regarded as a separate geographically dislocated antenna array that is connected to the same master controller (i.e., master eNB).

In case of UL synchronization, a timing alignment is needed for a switchover from the M-eNB 12 to a relay 14, since a distance between UE and the relay 14 is different from that of between UE 16 and M-eNB 12. This problem occurs in any relaying system of an LTE, as the LTE operation is asynchronous. Hence, this problem is open to any relaying-based operation of LTE.

At present, a Single Frequency Network (SFN) operation where all relays are synchronised with the M-eNB and RACH procedures are not normally needed as part of the Switchover operations—this is considered for optimal operation. To help the relay to calculate timing adjustments, the UE 16 that is to be switched over from the M-eNB to a relay is caused to send UL Demodulation RS on symbol 3 of each slot in the case of Type 1 frames.

UE Mobility in its IDLE Mode

In this mode, no relays 14 are involved, and hence in terms of what is expected from the network 10, this scenario is quite similar to a situation where the network does not consist any of the newly introduced relays 14.

UE Mobility in its ACTIVE Mode

The objective of this section is to explain how the EPS network consisting of the newly introduced R-eNBs or any other RNs supports mobility cases for ACTIVE UEs engaged in communication sessions. In this case, the active UE mobility support (also conventionally known as a handover and also including a new concept called a switchover, as will be explained hereinafter) is completely under the control of the network 10. The decision to move, as well as the choice for the target cell and the technology is made by the current serving master eNB based on measurements taken by the master eNB itself, relays and the terminal. There are thus two strategies:

1) make-before-break strategy, where the resources and contexts in the target nodes are reserved before the actual handover takes place; and

2) packet data forwarding strategy, whereby the source and target nodes communicate in order to transport the undelivered packets.

This section details how different important intra E-UTRAN mobility cases are supported in the EPS consisting of newly introduced relays.

Depending on the Service Level Agreement (SLA) of each user, the network 10 may decide whether a given user is entitled to use any of the deployed relays 14. For instance, when the SLA of a given user does not require GBR-like high bit-rate traffic, that particular user does not have to make use of any of the deployed relays 14. This is because its SLA is such that it can be comfortably supported by the eNB (master) irrespective of its locations. Therefore the UE 16 mobility in its ACTIVE mode works in line with the conventional procedures which are meant for LTE/LTE-A—i.e., the handover procedures of an EPS that does not consist of a relay. If the SLA is such that the UE 16 often expects GBR-like high-bit-rate traffic, then that user is allowed to make use of relay services, and hence the given UE is supported by the present Switchover procedures in addition to the conventional handover procedures. Accordingly, the mobility scenarios in the present embodiments are generally applicable to the UEs that are on a premium SLAs, although it does not necessarily mean that non-premium SLA subscribers should not be supported by the relays.

Intra E-UTRAN Mobility between R-eNB/RN and its Master eNB with Y2 Support

This is the simplest case of radio mobility in UE's ACTIVE mode. FIG. 10 shows the general architecture of an intra E-UTRAN mobility case. If this mobility happens either between a relay and its master eNB or between two relays belonging to the same master eNB 12, from L1 perspectives, the whole process will appear as if the traffic Switchover is between two different physically dislocated remote antenna arrays, which are connected directly to the same eNB.

To further aid understanding, an example is provided. Suppose that the UE 16 locates very close to the M-eNB 12 (itself being both the controlling node and a first node—the node supporting the current session), and all its traffic is handled initially by the M-eNB itself. While the on-going multimedia enriched application is being supported, the UE 16 moves towards the edge of the cell 12a. The master eNB 12 takes periodical measurements and determines that the signal strength is degrading. After it reaches a threshold, the master eNB 12 will run the relay selection algorithm shown in FIG. 7. In this process, the current master eNB will shortlist a group of relays 14 based on their proximity to the UE 16 in question. It is possible that any of the shortlisted relay may belong to different master eNBs—but the current master eNB should communicate with the neighbour master eNBs via the X2 interface for coordinating the measurement taking process required as part of the switchover/handover. This is because a direct communication between a master eNB 12 and a relay 14, which does not belong to that master, is ruled out for facilitating an easy and scalable operation. In this case, further assume that the selected relay (second node) also belongs to the same master eNB.

Once the most appropriate relay is chosen, the master eNB will first issue a quick wake-up call if that relay is in its STANDBY mode. Once woken up, the master eNB will allocate the right amount of REs/PRBs depending on UE's traffic demand, assign them to the chosen relay 14 and configure the radio resources, as long as the latter responds with a positive response. The whole procedure involved in this particular case, where the master eNB 12 switchovers a given traffic to a relay belonging to that master, is depicted in FIG. 11 in terms of a sequence diagram. The master eNB achieves this switchover in a user transparent way. In other words, the UE 16 in question does not have to know the existence of relays. In order to facilitate this relay 14 transparent operation, this switchover procedure is performed in a slightly different way.

As in a conventional handover, when the signal quality continues to drop, the serving Base Station (BS) will first shortlist a group of relays, as specified in FIG. 7, wake up the shortlisted relays in case any of them is in its STANDBY mode, coordinate with the relays to initiate transmitting RS on the arranged REs unless any of the chosen relays is already active (if a relay belongs to a different M-eNB, the respective master eNBs should coordinate with the relays for the RS transmission unless a given relay is already active), pass information regarding REs and relay-specific ID per chosen relay on to the UE 16 in question and instruct the UE to take periodic measurements and to report back to its master eNB. Once the UE's reported the measurement details back to its M-eNB 12, the M-eNB 12 will select the appropriate target relay (i.e, an R-eNB/RN) or cell (i.e, a M-eNB). From L1 perspectives, this traffic Switchover appears as if the traffic is handed over between two remotely dislocated different antenna arrays that are connected to the same eNB. This is true as long as the relays involved belong to the same master eNB. If not, it involves conventional handover procedure that is augmented with the switchover procedure.

Disclosed now is the scenario where UE traffic is switched over from the M-eNB to a slave relays. In FIG. 11, the source M-eNB configures the UE measurement procedures according to the area restriction information. Measurements provided by the source M-eNB may assist the function controlling the UE's connection mobility. Accordingly, the UE is triggered to send a MEASUREMENT REPORT as per the rules set. The source M-eNB makes a decision based on the MEASUREMENT REPORT and RRM information to perform either a switchover or a handover. The M-eNB 12 will then run a relay selection algorithm as specified in FIG. 7, choose the most optimal relay/M-eNB and notifies its decision. Once the target relay, belonging to the same master eNB, accepts the Relay Selection by the master eNB (i.e., source node), it may send the positive response. If the selected relay was initially in its STANDBY mode, the whole switchover process is preceded by a quick wake-up call. After having received the positive response from the selected target relay, the master eNB will allocate and configure the radio resources on the air interface for the selected relay with an objective to serve the UE 16 in question, and will start forwarding the data (i.e., all buffered downlink RLC SDUs that have not been acknowledged by the UE) to the new target relay via Y2 (X2-like) interface. Although this kind of buffered data forwarding is not essential in the case of a typical relay 14, mainly because an RN merely relays the traffic from the master eNB, it is preferable in the case of an R-eNB mainly because the latter maintains a separate S1-U-like interface. The UE 16 has to be then notified about the new RE/PRB details by the master eNB 12 through a PRB Switchover command (operation 10 in FIG. 11) for a seamless switchover. Given that PRB Switchover may often involve RB, Transport Channel or physical channel reconfiguration, it can be any of the RRC Procedures, namely RRCConnectionReconfiguration including radioresourceConfiguration. Given that the UE is synchronised with the M-eNB and the M-eNB, and its slave relays are synchronised, it is reasonable to expect that the UE will be synchronised with the target relay 14. Small time drift can be adjusted by getting the UE 16 that is to be switched over from the M-eNB to a relay to send UL Demodulation RS on symbol 3 of each slot in the case of Type 1 frames. This will help the target R-eNB/RN to calculate timing adjustments. In response to PRB Switchover, the UE 16 will send a PRB Switchover Confirm, which will trigger the path switch procedure only in the case of an R-eNB—this PRB Switchover Confirm can be an RRCConnectionReconfigurationComplete. Accordingly, the master eNB will make a Path Switch Request to the serving MME 20 only if the target relay is an R-eNB—please note that such a path switch request is not needed when the target relay is an RN. Given that R-eNBs do not maintain a control plane interface with any MME 20, the serving MME 20 has to release the old data tunnel via the master eNB 12 and replace it with a new one established via the target R-eNB—the essential signalling with the R-eNB should take place via the M-eNB as shown by operation 8 of FIG. 11. On the other hand, in the case of RN, a simple traffic switchover from the M-eNB to one of latter's slave RNs does not always necessarily require setting up of a new SAE bearer. In the whole switchover procedure, the UE 16 does not interact directly with the relay 14. Thus the switchover is effected from a first to a second node. It will be appreciated that in this scenario the M-eNB acts as both the first node and the controlling node.

The following occurs when a traffic switch takes place between two different relays 14 (first and second nodes) belonging to the same master eNB 12 (controlling node).

On seeing that the signal strength measurements of the UE 16 is degrading, the current serving relay 14 will inform its master (i.e., M-eNB) 12 by passing the current location information of the UE in question. The master will then run the relay selection algorithm of FIG. 7. Suppose the target relay 14 chosen by this algorithm belongs to the same master eNB 12 to which the source relay is also associated with. This is a simple scenario, and allows the master eNB 12 to accomplish this switchover in a very user transparent way, as illustrated in FIG. 12. The operations of FIG. 12 are similar to the switchover process shown in FIG. 11. The primary difference is that the switchover is triggered by the source relay sending a Switchover Request to its master eNB. The secondary difference is that once the relay selection and subsequent configuration of the chosen relay is successful, the master eNB will transmit the Switchover Response back to the source relay. This will allow the source relay to begin forwarding the unacknowledged RLC SDUs towards the target relay via Y1 (i.e., X2-like) interface, as shown in FIG. 11. If no such interface exists between adjacent relays, the master can coordinate the data forwarding via itself (i.e., from the source relay to the master eNB and then from the master eNB to the target relay) using the Y2 (X2-like) interface, as shown in FIG. 10.

Given that each R-eNB maintains an S1-U-like interface, a new SAE Bearer needs to be established as part of this switchover, as soon as the serving MME has been notified about the decision regarding the target R-eNB selection. This is not required in case an RN is used instead of an R-eNB. Hence, operations 10, 15, 16, 17 and 18 of FIG. 12 are only needed when R-eNBs are used.

Once this switchover has successfully taken place, the resources needs to be released from the source relay 14, and given that it is the M-eNB 12 that owns and configures resources in relays, the M-eNB 12 has to release the radio resources. In addition, in the case of R-eNBs being used, old SAE Bearer tunnel needs to be released as well. Once this is done, the old source relay will switch to the STANDBY mode (perhaps after a small timeout) if no active sessions are currently supported by that relay. Given that the master eNB coordinates and controls the whole switchover process in terms of deciding when the switchover is needed, amount of resource allocation needed to the target relay and timely resource release from the source relay if the source happens to be another relay belonging to the same master, please note that any relay plays little part in the allocation and release of resources.

The case where the switchover takes place from an R-eNB/RN 14 to its master eNB is now considered. FIG. 12 shows the operations involved in this case. As explained above, the source relay triggers the switchover operation with the dissemination of Switchover Request to its master eNB. The master will in turn run the relay selection algorithm. Assuming that the UE is in its ACTIVE mode and moves very close to the master eNB, it is selected by the algorithm as the target eNB. Hence, operations (6), (7) and part of (9) will be ignored, and the rest will follow as explained in relation to FIG. 12 in the previous scenario. Part of operation (9) is needed in the master eNB itself as it is going to be the target.

Thus, in this scenario, the switchover occurs between first and second nodes, with the master eNB being a controlling node.

There exists another case where the Switchover of the traffic takes place between two relays belonging to two different master eNBs. This scenario makes use of a mixture of switchover and conventional handover procedures. Thus, in this scenario, the switchover occurs between first and second nodes, with one of the master eNB being a controlling node.

Operation (4) of FIG. 13 triggers the switchover process, and the current master eNB (this master eNB is referred to here as the source master eNB) will run the relay Selection algorithm. Suppose the selected target relay belongs to a different master eNB of the neighbouring cell—this master eNB is called the target master eNB. At this stage the source master eNB will issue a Handover Request to the target specifying the relay ID of the target relay, and the rest of the procedures involved as part of this joint switchover+handover process is illustrated using FIG. 13.

On receiving the Handover Request message over X2 interface along with the specification of the intended target relay ID, the target master eNB will send the Relay Selection Request to the chosen relay and get a response from it. In case a positive response is received from the chosen relay, the target M-eNB will send a Handover request Ack. On reception of such an ACK, the source master eNB will respond back to the source relay with the Switchover Response. Once the source relay has been notified by its master eNB with the Switchover Response (operation 10 in FIG. 13), it will start forwarding the data (i.e., all buffered downlink RLC SDUs that have not been acknowledged by the UE) to the target relay via the respective master eNBs using the Y2 (X2-like) and X2 interfaces. These packets will be stored by the target relay until the UE is able to receive them. In addition, the previous Switchover Response triggers a Handover Command from the source M-eNB. This will be responded by the UE with a Handover Confirm. At this point, the target M-eNB will allocate the required physical resources (e.g., REs/PRBs) and assign it to the target relay. In case the chosen target relay was in its STANDBY mode, its master eNB would be responsible for waking it up.

From FIG. 13, the UE 16 in question has only a limited interaction directly with the relays—this is in relation to taking measurements when the UE is in the RRC-CONNECTED mode. In most other cases, all communications between the relays and the UE 16 are coordinated through the respective master eNBs. Once the UE 16 is synchronised with the target relay (by getting the UE that is to be handed over to send UL Demodulation RS on symbol 3 of each slot in the case of Type 1 frames), the target M-eNB 12 will send a Handover Confirm, which will trigger the path switch procedure to the serving MME 20. Radio resource allocation and configuration will also take place at this point in time.

In this scenario, the establishment of an SAE bearer is needed irrespective of whether the relays involved are R-eNBs or RNs.

Once the traffic is switched over to an R-eNB, the R-eNB will behave like a normal eNB as far as the UE 16 is concerned—hence the UE maintains little interaction with the master of its serving R-eNB. However, it is the serving relay that periodically passes the measurement reports pertaining to each UE it supports onto its master eNB and interacts with it for dynamic Radio Bearer reconfiguration, transport channel reconfiguration or physical channel reconfiguration of a given UE 16. When supporting an on-going session of a given UE, dynamic Radio Bearer reconfiguration, transport channel reconfiguration or physical channel reconfiguration is possible only when the serving relay communicates and gets the approval of its master in priory before it can performs these operations. This is because it is the master eNB 12 that owns and controls the radio resources within its domain. In other words, the Master-Slave operation between any relay and its master eNB is needed at the time of switchover/handover or in priory to facilitate these operations and for most of the RRM and RRC related operations for dynamic Radio Bearer reconfiguration, transport channel reconfiguration or physical channel reconfiguration. In other occasions, once an R-eNB has started serving a given UE, it will behave like an ordinary eNB (but not like a master though) only from user plane traffic transmission perspectives as it maintains necessary u-plane interfaces with the EPC. As a result, user plane traffic pertaining to a UE session flows directly via an R-eNB by-passing the M-eNB 12, and in this respect, an R-eNB does not relay u-plane traffic. This is not the case with an ordinary RN, as it is a typical relay and hence always need to relay traffic from the M-eNB.

In the case of R-eNB and L3 RN, radio bear allocation and assignment to both a UE and the R-eNB/L3-RN by the M-eNB adopts the same method as applicable to the existing LTE system (with minor modification). This is relatively simple and accomplished through relevant RRC procedures (e.g., RRCConnectionReconfiguration, RRCConnectionRelease, . . . ). However, RB assignment to RNs by the Master eNB is different in the case of L1/L2 RNs, and this is possible with an augmented Y2 interface and application protocol (similar to NBAP) to enable this atomic RB assignment process for L1/L2 RNs.

Further, an R-eNB/RN should employ PDCCH/PUCCH to deal with conveying the DL/UL grant, scheduling assignments, and to support ACK/NACK responses from the terminal for the DL transmissions. Similarly, each relay should make use of PHICH to support HARQ in the case of R-eNB and L2/L3 RN. These are again facilitated by the Master eNB, given the fact that the PDCCH/PCFICH/PHICH shares and occupies up to first three symbol periods in every sub-frame. More over, the standard allows the use of multiple PDCCHs in parallel during the same sub-frame period in order to allow for flexible and low latency scheduling. Segmentation of the PDCCH into smaller Control Channel Element (CCE) is also possible.

All control signalling such as paging, synchronisation, BCH transport channel broadcasts that are necessary for a camp-on process, and the RACH process are handled by the master eNB. Given that these control signalling do not necessitate high bandwidth, a UE can still be supported by an eNB (master), irrespective of UE's locations. However, some less critical information is broadcast on the DL-SCH, and this can be relayed by a relay. Accordingly, whenever a SI update occurs, any RRC CONNECTED mode UE, which is supported by an relay, should get the notification through the Paging from the M-eNB, and hence, whenever a SI change occurs, the M-eNB will inform both the relay and UEs. UEs will then get the required SIBs again on the DL-SCH—this is facilitated again by M-eNB through relevant dynamic RRC procedures (e.g., RRCConnectionReconfiguration, radioresourceConfiguration, RRCConnectionRelease) in the case of R-eNB and L3 RN. However, only in the case of R-eNB such SIBs needs to be relayed via Y2 interface before being forwarded by the R-eNB to the UE in question on DL-SCH. This is because Y2/X2 interface is there for forwarding the unacknowledged SDUs from the Source eNB to the target eNB at the time of Switchover or Handover. On the other hand, in the case of L1/L2 RNs, similar RB reconfiguration is facilitated through the Y2 interface (and the new Application protocol sitting in the Radio Network Control Plane), and the relay operation takes place as usual. Please note that in the case of L1/L2/L3 RNs, such SIBs need not be forwarded via Y2.

MBMS is supported by the R-eNBs/RNs in the same way as described in the previous paragraphs irrespective of whether it is multi-frequency or single-frequency based.

Switchover VS. Handover

Given that from the perspectives of the EPC the network operations performed by EPC as part of the switchover and handover are similar, switchover and handover are the same. It is from the perspectives of both UE and eNB, switchover is different from handover as shown in the following table.

| Handover | Switchover |
|---|---|
| UE is made aware of this | UE is not made aware of this |
| process | process. |
| The target node is | In case the target node is a |
| responsible for radio | relay, radio resource allocation |
| resource allocation and | and configuration is performed |
| configuration | by the respective master. |
| Always happens between | If happens in the same cell |
| base stations | covered by an eNB, it appears |
| | as a traffic switch between two |
| | different dislocated antenna |
| | arrays that is enabled by the |
| | master eNB through an Radio |
| | Bearer Procedure. |
| The UE has to get itself | Synchronisation is not needed |
| synchronised with the | as long as the Switchover takes |
| target BS before a HO | place within a single eNB |
| | domain - this is because it is |
| | the master that allocates and |
| | configures the radio resources |
| | at a relay, and hence the |
| | synchronisation with the |
| | master eNB is enough. |
| After a handover, a | After a switchover within a |
| RRC_CONNECTED UE | cell, this task may not be |
| shall apply the system | needed by a UE, as the UE is |
| information acquisition | still located within the same |
| procedure to acquire AS | cell, unless notified through |
| and NAS System | the SI change notification. |
| Information that is | |
| broadcast | |

It is to be appreciated that the foregoing detailed description is made for information purposes only, and is not meant to limit the scope of the present invention as set out in the accompanying claims.

1.-24. (canceled)

25. A Long Term Evolution (LTE)/Long Term Evolution advanced (LTE-A) network comprising:
1) a relay;
2) a controller in a master-slave arrangement with said relay; and
3) one or more user terminals,
wherein said controller is operable to control the status of said relay between a standby mode and an active mode dependent upon requests received from said user terminals.

26. A Long Term Evolution (LTE)/Long Term Evolution advanced (LTE-A) network according to claim 25, wherein the controller is an e-NodeB type node.

27. A Long Term Evolution (LTE)/Long Term Evolution advanced (LTE-A) network according to claim 25 or 26, wherein the network further comprises a relay gateway operable to assign a temporary identification to said relay.

28. A Long Term Evolution (LTE)/Long Term Evolution advanced (LTE-A) network according to claim 27, wherein the relay gateway is operable to assign the relay to the controller.

29. A Long Term Evolution (LTE)/Long Term Evolution advanced (LTE-A) network according to claim 27, wherein the relay gateway is a software implementation housed in a mobility management entity.

30. A Long Term Evolution (LTE)/Long Term Evolution advanced (LTE-A) network according to claim 25, wherein, in the said network, the relay is transparent to the user terminals and can be in either a standby mode or an active mode.

31. A Long Term Evolution (LTE)/Long Term Evolution advanced (LTE-A) network according to claim 30, wherein the relay does not support user terminal camping on process.

32. A Long Term Evolution (LTE)/Long Term Evolution advanced (LTE-A) network according to claim 25, wherein the said relay can invoke an attach procedure to join the network.

33. A Long Term Evolution (LTE)/Long Term Evolution advanced (LTE-A) network according to claim 25, wherein said relay is operable to revert from an active mode to a standby mode after a predetermined time of non-use has elapsed.

34. A Long Term Evolution (LTE)/Long Term Evolution advanced (LTE-A) network according to claim 25, wherein the network further comprises a relay, a serving gateway and a mobility management entity, wherein said relay maintains an interface with the serving gateway, but not with any mobility management entity, thereby only relaying user-plane traffic.

35. A Long Term Evolution (LTE)/Long Term Evolution advanced (LTE-A) network according to claim 25, wherein the relay is operable to synchronise with the controller using a Long Term Evolution (LTE) or Long Term Evolution advanced (LTE-A) air interface in the same manner as a user terminal achieves synchronisation.

36. A system for dynamically configuring radio resource in a wireless network, said network comprising:
a transceiver associated with a cell,
one or more relays operable to revert between standby or active mode
and one or more user terminals; wherein
said one or more user terminals are operable to communicate wirelessly with the transceiver; wherein
said network is operable to analysis requests from said one or more user terminals, and
based on said requests, said network decides whether or not the transceiver is able to handle the requests from said one or more user terminals, and if not, nominate the most appropriate relay from said one or more relays, by running a relay selection algorithm involving identifying the relay nodes that physically/geographically located close to one or more user terminals, waking up the relays that are in their standby mode, and taking both downlink and uplink measurements, wherein the said relay selection algorithm nominates the most appropriate relay based on the location of the said one or more relays and a signal strength of the said on or more relays, to handle the requests from one or more user terminals.

37. A system according to claim 36, wherein the transceiver is an e-NodeB type node.

38. A user equipment handover method for a wireless network, said network comprising:
i) a plurality of nodes, including an active controlling node, a first node and a standby second node; and
ii) a user terminal,
wherein said user terminal is currently located in the overlapping service regions of said controlling, first and the second nodes such that said user terminal always operable to camp on the controlling node and subsequently to initiate the service request, and on receiving the service request, the controlling node is operable to examine a request for a wireless communication session from the user terminal, and, should the controlling node ascertain that the first node is not capable of supporting the communication session of the user terminal, handing said request over to the second node as an optimal node for handover from the plurality of nodes after having reverted the state of the second node from the standby to an active state and performed handover measurements.

39. A user equipment handover method according to claim 38, wherein the first node is the controlling node.

40. A user equipment handover method according to claim 38 or 39, wherein, if the controlling node determines that the first node is unable to handle the communication session, the method comprises the following steps:
1) establishing a list of potential nodes, from the plurality of nodes, operable to receive connectivity to the user terminal based purely on their physical location with respect to that of a user equipment;
2) notifying the list to the user terminal and causing the user terminal to measure operating parameters of each of the nodes in said list and report back a measurement report to the controlling node;
3) causing the user terminal to perform UL sounding after having allocated the necessary resource elements and instructing the list of potential nodes to measure and report back a measurement report to the controlling node; and
on receiving the measurement reports from both the user terminal and said list of potential nodes, the controlling node establishes which node is the optimal node for said handover.

41. A user equipment handover method according to claim 38, wherein the controlling node, after receipt of the measurements from the user terminal, ascertains the quality of service requirements of the user terminal and determines the optimal node based on this information.

42. A user equipment handover method according to claim 38, wherein the controlling node is an eNodeB, and that the plurality of nodes further includes at least one relay node.

43. A user equipment handover method according to claim 42, wherein the e-NodeB is responsible for allocating, assigning and configuring the radio resources at the optimal node in an on-demand manner.
